(19) United States
(12) Patent Application Publication
(10) Pub. No.: US 2026/0071150 A1
(43) Pub. Date: Mar. 12, 2026

(54) MICROBIAL ENHANCED COMPOSITIONS WHICH OVERCOME ANTAGONISTIC SURFACTANT INCOMPATIBILITY

(71) Applicant: Stepan Company, Northbrook, IL (US)

(72) Inventors: Alexander N. Nikoloff, Wheeling, IL (US); Sangwook Lim, Chicago, IL (US); Ronald A. Masters, Wheeling, IL (US); Yonglin Ren, Houston, TX (US); Renaud Louis Benoit Perrin, Fontaine (FR)

(21) Appl. No.: 19/390,181

(22) Filed: Nov. 14, 2025

Related U.S. Application Data
(63) Continuation of application No. PCT/US2024/029283, filed on May 14, 2024.
(60) Provisional application No. 63/466,559, filed on May 15, 2023.
(60) Provisional application No. 63/611,458, filed on Dec. 18, 2023.

(51) Int. Cl. C11D 3/38; B09C 1/08; B09C 1/10; C11D 1/06; C11D 3/02; C11D 3/22; C11D 3/33

(52) U.S. Cl. CPC C11D 3/381; B09C 1/08; B09C 1/10; C11D 1/06; C11D 3/02; C11D 3/22; C11D 3/33; B09C 2101/00

(57) ABSTRACT

Disclosed are compositions comprising one or more surfactants that adversely affect viability, growth, and/or biological activity of beneficial microorganisms, and particular additives that overcome the adverse effect of the surfactant, thereby facilitating viability, growth, and biological activity of the beneficial microorganism. The additives that can overcome the adverse effect of the surfactant comprise at least one L-amino acid in combination with at least one of (a) inorganic divalent metal salts or (b) monovalent salts, and optionally, at least one carbohydrate, in particular amounts and ratios. Also disclosed is a method for overcoming the adverse effect that particular surfactants have on beneficial microorganisms by combining the surfactants with the particular additives. The compositions and method can be used in a variety of end use applications that employ beneficial microorganisms, including surface cleaning compositions, environmental remediation, and agricultural applications.

### RELATED APPLICATIONS

This application is a continuation of and claims priority to PCT Application No. US2024/029283, filed May 14, 2024, which claims priority to U.S. Provisional Patent Application No. 63/611,458 having a filing date of Dec. 18, 2023, and to U.S. Provisional Patent Application No. 63/466,559, having a filing date of May 15, 2023, each of which is incorporated herein by reference in its entirety.

### BACKGROUND OF THE INVENTION

The present technology relates to compositions comprising one or more surfactants that adversely affect viability, growth, and/or biological activity of beneficial microorganisms, and particular additives that overcome the adverse effect of the surfactant, thereby facilitating viability, growth, and biological activity of the beneficial microorganism. The present technology also relates to a method for overcoming the adverse effect that particular surfactants have on beneficial microorganisms by combining the surfactants with the particular additives.

There has been a recent trend to formulate products using the whole cell of beneficial microorganisms, such as various Bacillus bacteria species, to enable improved results. For example, bacterial spores may be added to cleaning formulations to provide a long-term cleaning effect. Bacterial spores may also be used in agricultural applications to manage pests and enhance the health and vitality of plants, and in bioremediation compositions to better promote the biodegradation of organic contaminants. When in spore form, the beneficial microorganisms do not provide any particular benefit to the composition. In order to obtain performance benefits, the spores must germinate, grow, and exert biological activity when needed. With favorable environmental conditions of pH, ionic strength, and nutrients (such as proteins and oils), the beneficial microorganism spores can germinate and convert into vegetative cells, at which point the microorganism produces enzymes, metabolites, digests organic materials (for example, embedded soil), solubilizes inorganic plant nutrients, and promotes a healthy microbiome, crowding out and outcompeting non-beneficial and pathogenic microorganisms.

An important issue for germination, growth, and biological activity is the compatibility of the beneficial microorganism with other components in the formulation. It has now been found that many surfactants used in, for example, cleaning compositions, agricultural compositions, and bioremediation compositions, create an environment that is unfavorable for the microorganism. Surfactants that can adversely affect the viability of beneficial microorganisms include many common anionic surfactants, such as alkyl sulfates and alkyl ether sulfates, and most amphoteric surfactants. Other surfactants that adversely affect beneficial microorganisms include rhamnolipids, which are interface-active glycolipids produced by various bacterial species. Adding beneficial microorganisms to compositions containing these surfactants does not provide the desired benefits because the beneficial microorganisms fail to germinate or, after germination, fail to grow, multiply, or survive.

Another important consideration for compositions comprising beneficial microorganisms is the ability to maintain the microorganisms in a stable suspension during storage and use. Microorganisms that have settled to the bottom of the container may not be adequately dispersed with shaking or stirring, resulting in uneven or inconsistent application of the microorganisms.

There is therefore a need for compositions containing beneficial microorganisms that can maintain the viability of the microorganisms during storage and allow the beneficial microorganisms to germinate and grow during use. There is also a need for compositions that are storage stable and can maintain the microorganisms suspended.

Applicants have determined that particular additives in particular amounts and ratios can be combined with surfactants that exhibit an adverse effect on beneficial microorganisms, and that the additives can overcome the adverse effects the surfactant has on the beneficial microorganism, thereby facilitating viability and growth of the microorganisms. Use of these additives in microbial enhanced compositions maintains the viability of the beneficial microorganisms while also advancing U.N. Sustainability Goals (“SDG”). Many biosurfactants, such as rhamnolipids, and other bio-based surfactants are antagonistic towards beneficial microorganisms, and the additives described herein enable broader use of such bio-based surfactants in a variety of different applications. Both rhamnolipids and beneficial microorganisms, such as Bacillus species, are made by fermentation, a less energy intensive bio-based manufacturing process, using renewable resources and generating biodegradable waste products that are less impactful on the environment. These benefits further SDG #12 (Responsible Consumption and Production).

### BRIEF SUMMARY OF THE INVENTION

In one aspect, the present technology provides a composition for overcoming antagonistic surfactant incompatibility between a surfactant and a live beneficial microorganism, wherein the surfactant incompatibility adversely affects viability, growth, or biological activity of a live beneficial microorganism, the composition comprising (a) at least one surfactant that exhibits antagonistic surfactant incompatibility when in contact with a live beneficial microorganism and adversely affects viability, growth, or biological activity of the live beneficial microorganism; (b) an additive comprising (i) at least one L-amino acid in combination with at least one of inorganic divalent metal salts or monovalent salts in an amount to provide a weight ratio of additive component (i) to surfactant of 0.2:1 to 1:1; and (ii) optionally, at least one carbohydrate; and (c) water to total 100% by weight of the composition, wherein, when the composition is combined with the live beneficial microorganism, the additive in the composition overcomes the antagonistic surfactant incompatibility between the at least one surfactant and the live beneficial microorganism, and facilitates viability, growth, and biological activity of the beneficial microorganism.

In a further aspect, the present technology provides a method for overcoming surfactant incompatibility between a surfactant and a live beneficial microorganism, wherein the surfactant incompatibility adversely affects viability, growth, or biological activity of a live beneficial microorganism, the method comprising (a) providing an aqueous composition comprising at least one surfactant that exhibits antagonistic surfactant incompatibility when in contact with a live beneficial microorganism and adversely affects viability, growth, or biological activity of the live beneficial microorganism; (b) combining an additive with the aqueous composition, wherein the additive comprises (i) at least one L-amino acid in combination with at least one of inorganic divalent metal salts or monovalent salts in an amount to provide a weight ratio of additive component (i) to surfactant of 0.2:1 to 1:1; and (ii) optionally, at least one carbohydrate; and (c) combining the live beneficial microorganism with the aqueous composition before step (b) or after step (b); wherein the additive overcomes the antagonistic surfactant incompatibility between the at least one surfactant and the live beneficial microorganism, and facilitates viability, growth, and biological activity of the beneficial microorganism.

In another aspect, the present technology is suitable for bioremediation applications and provides a method for environmental remediation of soil. The method comprises (a) applying an aqueous composition comprising from 0.1% to 25% by active weight rhamnolipids to the soil to be remediated; and (b) applying a composition to the soil to be remediated, wherein the composition comprises (i) an additive comprising a blend of L-amino acids and divalent metal salt in an amount of 0.1% to 25% by weight of the composition, and optionally, at least one carbohydrate in an amount not greater than the weight of the blend of L-amino acid and divalent metal salt in the composition, (ii) live beneficial microbial spores in an amount of 1×10⁶ to 1×10¹⁰ CFU/g, and (iii) a carrier to total 100% by weight of the composition.

In another aspect, the present technology provides a microbial enhanced cleaning composition comprising (a) about 0.05% to 1.0% by active weight of at least one surfactant that exhibits antagonistic surfactant incompatibility when in contact with a live beneficial microorganism and adversely affects viability, growth, or biological activity of the live beneficial microorganism; (b) about 0.05% to 1.0% by weight of an additive that overcomes the antagonistic surfactant incompatibility between the at least one surfactant and the live beneficial microorganism, and facilitates viability, growth, and biological activity of the beneficial microorganism, the additive comprising (i) at least one L-amino acid; (ii) at least one inorganic divalent metal salt or at least one monovalent salt, or a combination thereof; and (iii) optionally, at least one carbohydrate, wherein additive components (i) and (ii) are present in the composition in an amount to provide a weight ratio of additive components (i) and (ii) to surfactant of 0.2:1 to 1:1; (c) microbial spores in an amount of 1×10⁴ to about 1×10⁸ CFU/g; and (d) water to total 100% by weight of the composition.

In a further aspect, the present technology provides a composition for overcoming antagonistic surfactant incompatibility between an alkyl ether sulfate surfactant and a live beneficial microorganism, wherein the surfactant incompatibility adversely affects viability, growth, or biological activity of a live beneficial microorganism, the composition comprising (a) an alkyl ether sulfate surfactant that exhibits antagonistic surfactant incompatibility when in contact with a live beneficial microorganism and adversely affects viability, growth, or biological activity of the live beneficial microorganism; (b) an additive comprising (i) at least one monovalent salt and (ii) at least one inorganic divalent metal salt, wherein the additive and the alkyl ether sulfate surfactant are at a weight ratio of alkyl ether sulfate surfactant to additive of 0.2:1 to 1:1; (c) an alkoxylated castor oil; and (d) water to total 100% by weight of the composition, wherein when the composition is combined with the live beneficial microorganism, the additive and the alkoxylated oil in the composition overcome the antagonistic surfactant incompatibility between the alkyl ether sulfate surfactant and the live beneficial microorganism, and facilitate viability, growth, and biological activity of the beneficial microorganism.

In some embodiments, the composition can be in the form of a liquid concentrate that is diluted prior to use at dilution ratios of 1:1000, 1:400, 1:100, 1:64, 1:32, 1:16, or 1:10, among others. In other embodiments, the composition can be a ready to use (RTU) composition in which the active ingredients are in amounts suitable for use.

### BRIEF DESCRIPTION OF THE DRAWINGS

FIG. 1 is a contour plot prepared from the test compositions of Example 1 comprising rhamnolipids and different amounts of additives without glucose.

FIG. 2 is a contour plot prepared from the test compositions of Example 1 comprising rhamnolipids and different amounts of additives including glucose.

FIG. 3 is a contour plot prepared from the test compositions of Example 2 comprising alkyl sarcosinate surfactant and different amounts of additives.

FIG. 4 is a contour plot prepared from the test compositions of Example 3 comprising alpha sulfonated alkyl esters and different amounts of additives without glucose.

FIG. 5 is a contour plot prepared from the test compositions of Example 3 comprising alpha sulfonated alkyl esters and different amounts of additives including glucose.

FIG. 6 is a photograph comparing the biological activity in test samples comprising mid-Hydrophilic-Lipophilic Balance (“HLB”) surfactants with and without additives.

FIG. 7 is a photograph comparing the biological activity in test samples comprising low-HLB surfactants with and without additives.

FIG. 8 is a photograph comparing the biological activity in test samples comprising dispersants with and without additives.

FIG. 9 is a photograph comparing the biological activity in test compositions comprising hydroxysultaine surfactant with and without additives.

FIG. 10 is a contour plot showing results from stability and oil digestion testing for compositions comprising alpha sulfonated alkyl esters and different amounts of additives.

FIG. 11 is a photograph comparing the biological activity in test compositions comprising different amounts of additives.

FIG. 12 is a photograph comparing the biological activity in test compositions comprising different potassium salts.

FIG. 13 is a photograph comparing the biological activity in test compositions comprising different magnesium salts.

FIG. 14 is a photograph comparing the biological activity in test samples comprising different propylene oxide-containing alcohol alkoxylate surfactants with and without additives.

### DETAILED DESCRIPTION OF THE INVENTION

### Definitions

“Beneficial microorganism” refers to a microorganism that provides positive effects on the health and well-being of living organisms and ecosystems.

“Antagonistic surfactant incompatibility” refers to a surfactant that adversely affects the viability, growth, and biological activity of a beneficial microorganism.

“Adversely affects” or “adverse effects” refers to disruption of biological capacity (such as germination), growth potential, or biological activity of beneficial microorganisms. Such disruption includes disruption of any of the steps involved in the microorganism's life cycle, such as sporulation or germination of spores and conidia, production of metabolites and enzymes to digest food sources, metabolism of those food sources, and maintenance and/or growth of the beneficial organism population.

“Biological activity” refers to the various processes and functions that microorganisms perform in their environment, including their ability to grow, reproduce, metabolize nutrients, release enzymes and metabolites, internalize or bind molecules, produce and respond to signals, promote nutrient cycling and availability, and interact with other organisms.

“Microbial enhanced composition” refers to a composition comprising at least one surfactant that provides primary benefits of lowered aqueous surface tension, wetting of substrates such as soil, leaves, or hard and soft surfaces, and at least one beneficial live microorganism.

“Inhibitory surfactant” refers to a surface active agent that, when used at levels which provide lowered aqueous surface tension, wetting of substrates such as soil, leaves and hard and soft surfaces, adversely affects the germination, growth, and/or biological activity of the added beneficial microorganism(s) when combined in use or in a common composition.

“Overcome surfactant incompatibility” or “overcoming surfactant incompatibility” refers to the ability of an additive to facilitate biological activity of beneficial microorganisms when the additive and beneficial microorganisms are in the presence of an inhibitory surfactant, as indicated by a decrease in drop size or the appearance of haze after 2-6 days, when determined in accordance with the test methods described in the Examples.

“Carbohydrates” as used herein include simple sugars and complex molecules such as but not limited to monosaccharides and disaccharides, including glucose, fructose, galactose, sucrose, lactose, maltose, xylose; polysaccharides such as starch, fiber, maltodextrin, amylose, amylopectin, glycogen; and complex sources such as molasses.

“Biorenewable Carbon Index” (BCI) refers to a calculation of the percent carbon derived from a biorenewable resource and is calculated based on the number of biorenewable carbons divided by the total number of carbons in the entire molecule.

“Biorenewable” is defined herein as originating from animal, plant, or marine material.

The terms “active”, “% active”, and “% active weight” refer to the amount of the active ingredient without regard to the amount of water or other solvent that may be present with the ingredient.

A “ready-to-use” or “RTU” product, composition or formulation of the present technology refers to a product, composition, or formulation that is ready to be applied or used as-is.

A “dilutable,” “concentrate,” or “dilutable concentrate” product, composition, or formulation of the present technology refers to a product, composition, or formulation that needs to be diluted with a diluent (e.g., water) in a ratio of, for example, 1:1000, 1:400, 1:100, 1:64, 1:32, 1:16, or 1:10, among others, before it can be applied or used for its intended purpose.

As defined herein, a “rhamnolipid” is a glycolipid that has a lipid portion that includes one or more, typically linear, saturated or unsaturated β-hydroxy-carboxylic acid moieties and a saccharide portion of one or more units of rhamnose. The saccharide portion and the lipid portion are linked via a β-glycosidic bond between the 1-OH group of a rhamnose moiety of the saccharide portion and the 3-OH group of a β-hydroxy-carboxylic acid of the lipid portion. Thus, the carboxylic acid of one carboxylic acid moiety defines the end of the rhamnolipid. Where more than one rhamnose-moiety is included in a rhamnolipid, each of the rhamnose moieties not linked to the lipid portion is linked to another rhamnose moiety via a 1,4β-glycosidic bond. In embodiments where two or more β-hydroxy-carboxylic acids are present in a rhamnolipid, the β-hydroxy-carboxylic acid moieties are selected independently from each other. β-hydroxy carboxylic acid moieties may in some embodiments be identical. In some embodiments, they are different from each other.

The present technology is based on the discovery that many useful important classes of surfactants are antagonistic to beneficial microorganisms at surfactant use levels well below the levels required for typical product performance. However, it has now been found that particular additives can be combined with the surfactants to overcome the surfactant incompatibility and render the surfactants usable in compositions that include the beneficial microorganisms. As a result, the beneficial microorganisms in the compositions are able to germinate, grow, and exert biological activity when the additives are used in combination with one or more of these incompatible surfactants. Not to be bound by any particular theory, it is believed that the combination of specific additives in selected amounts and ratios provides the desired effect of overcoming the antagonistic surfactant incompatibility.

The compositions of the present technology comprise at least one surfactant that is incompatible with a beneficial microorganism. Incompatibility between a surfactant and a beneficial microorganism has been investigated in various ways, such as a standard Zone of Inhibition test, a standard agar plating test, or a standard resazurin (7-hydroxy-10-oxidophenoxazin-10-ium-3-one, sodium) (a blue fluorogenic dye) compatibility assay. In a Zone of Inhibition test, microorganisms are grown, cultured, diluted down to target levels, and then applied to a Petri dish containing agar nutrients. Test samples containing the surfactant of interest are diluted and loaded into an agar well created within the agar nutrient. The plates are incubated and microorganism growth is allowed to develop. The test sample diffuses through the agar and, if the surfactant in the test sample has an inhibitory effect on the microorganism, a lack of growth halo will be observed around the sample loaded well. This halo is referred to as the zone of inhibition. The larger the zone, the bigger the effect of inhibition. Major suitability limitations for non-antibiotics test samples for this test method are inherent large dilution of active, agar diffusion challenges, and nutrient media incompatibilities (neutralization, precipitation, etc). Although this method has been used in the medical field for antibiotics very successfully for decades, it has low suitability when testing non-antibiotic samples. In a standard agar plating test, test samples containing the surfactant of interest and microorganisms are exposed, diluted several orders of magnitude, and plated onto a nutritive agar that is incubated. After an incubation period appropriate for the species, the microorganism growth pattern is evaluated against appropriate controls. This method is suitable for evaluation of live counts over time, however, not very suitable for testing of inhibition due to the significant serial dilutions that remove all coformulants from the microbial species tested on the evaluative agar plate. In a resazurin-based test, test samples containing the surfactant of interest are mixed with reduced microbial nutrients, the beneficial microorganism, and resazurin in liquid suspension. The test samples are incubated and then inspected for colorometric and fluorescence change. Test samples that are blue and have low fluorescence indicate no biological activity and incompatibility between the surfactant and the microorganism. Test samples that are pink and have high fluorescence indicate biological activity and compatibility of the surfactant with the microorganism. This test and other similar liquid suspension tests address the previously mentioned traditional test limitations and provide a suitable, microorganism agnostic, high-throughput platform to evaluate inhibitive effects of surfactants with biologicals.

Surfactants that have been found to be incompatible with beneficial microorganisms at surfactant concentrations of 1 g/L or less include some anionic surfactants, some non-ionic surfactants, most, if not all, amphoteric surfactants, and most, if not all, cationic surfactants. Specific incompatible surfactants include alkyl sulfates, alkyl ether sulfates, alkyl sarcosinates, alkyl glutamates, alpha sulfonated alkyl esters, alkyl sulfonates, alkyl sulfoacetates, some alkyl phosphate esters, sulfosuccinates, rhamnolipids, hydroxy sultaines, alkyl betaines, alkyl amidopropyl betaines, alkyl amine oxides, alkyl amine alkoxylates, quaternized alkyl amine alkoxylates, some alcohol alkoxylates, mono- and/or diglycerides, and some EO/PO block copolymers. It is contemplated that any of these incompatible surfactants can be used in the compositions of the present technology and rendered compatible with beneficial microorganisms through the combination of the additives described herein with the surfactant.

The amount of surfactant in the compositions will vary depending on whether the composition is a concentrate that is intended to be diluted before use with water or other diluent, or whether the composition is a ready-to-use composition in which the active components are already at end-use concentrations. Surfactant amounts may also depend on the particular inhibitory surfactant in the composition and the end use. Surfactant amounts in a concentrate composition may be in the range of about 5% to about 20% by active weight, based on the total weight of the composition. For a ready-to-use composition, the surfactant amounts may be in the range of 0.05% to about 1% by active weight, based on the total weight of the composition.

The compositions of the present technology also include additives that can be combined with the surfactant to overcome the antagonistic surfactant incompatibility between the surfactant and the beneficial microorganism, and facilitate viability, growth, and biological activity of the beneficial microorganism. In some embodiments, the additives comprise at least one L-amino acid in combination with at least one of inorganic divalent metal salts or monovalent salts. Depending at least in part upon the particular surfactant used in the composition, the additives can be a combination of the L-amino acid with the divalent metal salt, a combination of the L-amino acid with the monovalent salt, or a combination of the L-amino acid with both the divalent metal salt and the monovalent salt. The additives may also include a carbohydrate as an optional component. In other embodiments, depending on the particular surfactant used in the composition, the additives may comprise a combination of divalent metal salt and monovalent salt without an L-amino acid.

The L-amino acid can be one or more L-amino acids selected from the group consisting of L-histidine, L-isoleucine, L-leucine, L-lysine, L-methionine, L-phenylalanine, L-threonine, L-tryptophan, L-valine, L-alanine, L-asparagine, L-aspartic acid, L-glutamic acid, L-serine, L-arginine, L-cysteine, L-glutamine, L-glycine, L-proline, and L-tyrosine. In some embodiments, the L-amino acid is L-alanine.

The inorganic divalent metal salt can be one or more of magnesium chloride, calcium chloride, manganese chloride, iron chloride, copper chloride, zinc chloride, cobalt chloride, magnesium nitrate, magnesium sulfate, calcium sulfate, manganese sulfate, iron sulfate, copper sulfate, zinc sulfate, colbalt sulfate, magnesium citrate, calcium citrate, hydrates of any of the foregoing, or combinations of any of the foregoing. In some embodiments, the divalent metal salt is magnesium chloride or a hydrate thereof.

The monovalent salt can be one or more of potassium nitrate, sodium nitrate, potassium chloride, potassium iodide, potassium manganese oxide, potassium sulfate, sodium bicarbonate, sodium sulfate, ammonium nitrate, ammonium sulfate, ammonium chloride, sodium citrate, potassium citrate, ammonium citrate, or combinations thereof. In some embodiments, the monovalent metal salt is potassium nitrate.

The additives can optionally include a carbohydrate, which may provide a food source for the beneficial microorganism and enhance the extent of growth of the microorganism. The carbohydrate can be one or more of glucose, maltose, galactose, fructose, sucrose, lactose, molasses, glycogen, or glucans. In some embodiments, the carbohydrate is glucose. If a carbohydrate is included in the additive, the amount is preferably not greater than the total weight of the other additive components (L-amino acid, divalent metal salt and/or monovalent salt) in the additive.

The total amount of additives in the compositions of the present technology will vary depending on whether the composition is a concentrate or a ready-to-use composition. The total additive amount in a concentrate composition may be in the range of about 5% to about 20%, alternatively about 5% to about 10% by active weight, based on the total weight of the composition. For a ready-to-use composition, the total additive amounts may be in the range of 0.05% to about 1% by active weight, based on the total weight of the composition. The amount of additive will also depend on the amount of surfactant in the composition. The weight ratio of additive (L-amino acid, divalent metal salt and/or monovalent salt) to surfactant in the composition may be in the range of 0.20:1 to about 1:1. In some embodiments, the compositions of the present technology comprise about 1% by weight of additives (L-amino acid, divalent metal salt and/or monovalent salt) for every 1 wt % surfactant active in the composition, and the weight ratio of surfactant to additive (not including the weight of the carbohydrate, if present) may be about 1:1. In some embodiments, the compositions of the present technology may comprise a weight ratio of surfactant to additive of about 5:1. The specific amounts and relative ratios of the L-amino acid, divalent metal salt, and monovalent salt in the additive can vary depending, at least in part, on the surfactant in the composition and whether a carbohydrate is included in the additives. For inhibitory surfactants that contain a carboxylate moiety, such as rhamnolipids and sophorolipids, the divalent metal salt should be included as one of the additives to overcome the inhibitory effect on the beneficial microorganism. For inhibitory surfactants that do not include a carboxylate moiety, the inhibitory effect can be overcome if the additives do not comprise, or contain only minor amounts of the divalent metal salt.

In some embodiments, the surfactant in the composition is a rhamnolipid surfactant and the additives comprise an L-amino acid and a divalent metal salt. Rhamnolipids are naturally derived and therefore have a BCI of 100. The L-amino acid and divalent metal salt can be combined in any weight proportion, but a preferred weight ratio of L-amino acid to divalent metal salt is 1:1 or greater. If a carbohydrate, such as glucose, is included with the L-amino acid and divalent metal salt additives, a weight ratio of divalent metal salt to L-amino acid of 1:1 or greater is preferred. In other embodiments when a rhamnolipid is the surfactant, the additives may comprise a combination of L-amino acid, divalent metal salt, and monovalent salt, and optionally, a carbohydrate. When a carbohydrate is not included in the additives, a preferred weight ratio of additive components is a weight ratio of (divalent metal salt+L-amino acid) to monovalent salt of 4:1 or greater. A particularly preferred additive blend for use with rhamnolipid surfactants comprises 0.7 wt % divalent metal salt, such as magnesium chloride hydrate, 0.15 wt % monovalent salt, such as potassium nitrate, and 0.15 wt % L-amino acid, such as L-alanine, for each 1 wt % active rhamnolipid surfactant. When a carbohydrate is present in the additive, a preferred weight ratio of the additive components is divalent metal salt to (L-amino acid+monovalent salt) of 1:1 or greater.

In some embodiments, the surfactant in the composition comprises an alkyl sarcosinate surfactant, and the additives comprise an L-amino acid, a monovalent salt, and a carbohydrate. Preferably, the alkyl sarcosinate surfactant is derived from a natural source, and has a BCI of at least 80, alternatively at least 90, alternatively at least 95, and preferably 100. Since divalent metal salts can co-precipitate with alkyl sarcosinates, it may be desirable to use additives that do not include a divalent metal salt when the surfactant comprises an alkyl sarcosinate. However, divalent metal salts can be included in an amount of up to about 10 wt %, based on the total weight of the additives, and still overcome the inhibitory effect of the alkyl sarcosinate surfactant. In some embodiments, the additives may comprise L-amino acid, monovalent salt, and a carbohydrate, such as glucose, in a weight ratio of (monovalent salt+L-amino acid) to carbohydrate of 1:1 or greater. Alternatively, the additives may comprise L-amino acid, monovalent salt, and a carbohydrate in a weight ratio of monovalent salt to (L-amino acid+carbohydrate) of 2:1 or greater. In one embodiment, the additive blend for use with alkyl sarcosinate surfactants comprises 0.45 wt % monovalent salt, such as potassium nitrate, and 0.45 wt % L-amino acid, such as L-alanine, and 0.1 wt % divalent metal salt, such as magnesium chloride hydrate, for each 1 wt % active alkyl sarcosinate surfactant.

In some embodiments, the surfactant in the composition comprises an alpha sulfonated alkyl ester, and the additives comprise an L-amino acid, a divalent metal salt, a monovalent salt, and optionally a carbohydrate. Preferably, the alpha sulfonated alkyl ester surfactant is derived from a natural source, and has a BCI of at least 80, alternatively at least 90, alternatively at least 95, and preferably 100. When a carbohydrate is not included in the additives, a preferred weight ratio of additive components is a weight ratio of (L-amino acid+monovalent salt) to divalent metal salt of 3:1 or greater. When a carbohydrate is present in the additive, a preferred weight ratio of the additive components is monovalent salt to (L-amino acid+divalent metal salt) of 1:1 or greater. The amount of the carbohydrate, when present, may be in an amount not greater than the total amount of the other additives in the composition. In one embodiment, the additive blend for use with alpha sulfonated alkyl ester surfactants comprises 0.45 wt % monovalent salt, such as potassium nitrate, 0.45 wt % L-amino acid, such as L-alanine, and 0.1 wt % divalent metal salt, such as magnesium chloride hydrate, for each 1 wt % active alpha sulfonated alkyl ester surfactant.

The compositions of the present technology, when combined with beneficial microorganisms, facilitate the viability, growth, and biological activity of the beneficial microorganisms. The beneficial microorganisms that can be used in combination with the compositions can be bacteria, fungi, yeast, or mold, and can be pores (also referred to as spores), vegetative, conidia, or mycelium cells. In some embodiments, the bacterial endspores are of the Bacillus genus. The Bacillus spores can be one or more of Bacillus amyloliquefaciens, Bacillus brevis, non-pathogenic variants of Bacillus cereus (such as toyoi), Bacillus circulans, Bacillus clausii, Bacillus coagulans, Bacillus firmus, Bacillus halodurans, Bacillus lentus, Bacillus licheniformis, Bacillus megaterium, Bacillus methylotrophicus, Bacillus mycoides, Bacillus pasteurii, Bacillus, polyfermenticus, Bacillus polymyxa, Bacillus pumilus, Bacillus simplex, Bacillus sphaericus, Bacillus stearothermophilus, Bacillus subtilis, Bacillus thiaminolyticus, Bacillus thuringiensis, and combinations thereof. In some embodiments, the beneficial microorganisms are blends of bacterial spores of two or more species, particularly blends of two or more Bacillus species. Blends of Bacillus spores of different Bacillus species are commercially available from different sources. Blends of Bacillus spores may include spores from one or more of Bacillus subtilis, Bacillus amyloliquefaciens, Bacillus licheniformis, Bacillus megaterium, Bacillus thuringiensis, and Bacillus pumilus.

The amount of the beneficial microorganisms that can be combined with the compositions of the present technology will depend on the end use for the composition, but will generally be at least 1×10⁴ CFU/g, more preferably at least 1×10⁵ CFU/g. When the composition is a concentrate that will be diluted prior to use, the amount of beneficial microorganisms can be in the range of 1×10⁷ to 1×10¹⁰ CFU/g, preferably 1×10⁹ to 5×10⁹ CFU/g. When the composition is a ready-to-use composition, the amount of the beneficial microorganism can be in the range of 1×10⁴ to 1×10⁹ CFU/g, alternatively 1×10⁴ to 1×10⁸ CFU/g, alternatively 1×10⁵ to 1×10⁹ CFU/g, alternatively 1×10⁵ to 1×10⁸ CFU/g.

In addition to overcoming antagonistic surfactant incompatibility and facilitating the viability, growth, and biological activity of beneficial microorganisms, the additives of the present technology unexpectedly can improve the dispersity and stability of the beneficial microorganisms in water-thin aqueous compositions, and prevent or minimize spore agglomeration. This additional benefit can be obtained whether or not an incompatible surfactant is present in the aqueous composition.

The compositions of the present technology can include optional ingredients depending on end use of the compositions. Such other optional ingredientscan include additional surfactants, hydrotropic or other solubilizing agents for obtaining and maintaining a clear single-phase concentrate or ready-to-use composition, additional carbohydrates, other than those mentioned above, builders, pH adjustment agents, electrolytes for enhancement of surfactant detergency, enzymes for cleaning enhancement, fragrances for different attractive smells, dyes for pleasing color, preservatives, and other functional ingredients. Preferably, any optional ingredients are compatible with the beneficial microorganism.

Surfactants that have been found to be compatible with the beneficial microorganisms and can be included in the composition as additional surfactants include, but are not limited to, castor oil ethoxylates, alpha olefin sulfonates, such as BIO-TERGER AS-40, a C14-16 olefin sulfonate, polyoxyethylene sorbitan monooleates, such as those sold under the tradenames TWEEN® and SPAN®, certain alk(en)yl dimethyl amides, such as STEPOSOL MET-10U, an unsaturated C10 N, N-dimethyl amide, a blend of sodium alkyl ether sulfate with alkyl amidopropyl betaine and/or alkyl betaine, and combinations thereof. In some embodiments, it has been found beneficial to combine a castor oil ethoxylate with the additive to improve the ability of the additive to overcome the incompatibility between a surfactant and the live beneficial microorganism.

Hydrotropes suitable for use in the compositions of the present technology include sodium xylene sulfonate, cumene sulfonate, amphoteric dipropionate salt, and combinations thereof. Suitable carbohydrates include cellulose, maltodextrin, fiber, amylose, amylopectin, glycogen, starch, or combinations thereof. Builders that have been found to be compatible with beneficial microorganisms include sodium gluconate and sodium citrate dihydrate.

Enzymes can be included in the compositions of the present technology to enhance cleaning. Suitable enzymes include proteases, amylases, and lipases.

Preservatives may be included in the compositions of the present technology, provided the amount of the preservative is at a level that does not affect the viability, growth, and/or biological activity of the beneficial microorganism at use dilutions of the composition. Examples of preservatives that could be used include, but are not limited to, phenoxyethanol, isothiazolinones and/or benzisothiazolinone, benzyl alcohol, organic acids, such as fatty acids and benzoic acid or benzoate salts with suitable pH adjustment or combinations thereof.

The compositions of the present technology can be used in combination with the beneficial microorganisms for a variety of end uses. In particular, it is contemplated that the compositions of the present technology could be used for any end use that employs a beneficial microorganism and an inhibitory surfactant. Such end uses can include microbial enhanced cleaners, including detergents for hard and soft surfaces, agricultural biopesticide and biofungicide formulations, personal care formulations, bioremediation, wastewater treatment, fermentation, probiotics, animal health, aquaculture, water reclamation, and food applications.

As one example, the compositions of the present technology can be combined with microbial spores to form a microbial enhanced cleaning composition. Upon use of the composition for cleaning surfaces, the spores germinate and digest soils that are often not accessible during initial cleaning, such as soils embedded in porous surfaces such as grout, floors, and counters. The surfactant(s) in the cleaning composition provide initial cleaning of the surfaces, while the additives in the composition enable viability and growth of the microbial spores to provide enhanced cleaning. It is envisaged that the microbial enhanced cleaning compositions employing the additives described herein can be formulated without the microbial spores, which can be added to the composition at the time of use. Alternatively, the microbial enhanced compositions could be formulated to include the microbial spores, along with the surfactant(s) and additives.

The microbial enhanced cleaning compositions can be formulated, for example, as a ready-to-use product or dilutable concentrate product. A concentrated product may be up to a factor of 1000× the ready-to-use component levels. Whether in a ready-to-use form or a dilutable concentrate, the end use concentrations of the components are equivalent. End use concentrations can comprise about 0.05 wt % to about 1 wt % surfactant active, about 0.05 wt % to about 1 wt % total additives, and about 1×10⁴ to about 1×10⁸, alternatively about 1×10⁵ to about 1×10⁸ CFU/g beneficial microorganisms. Dilutable concentrates may comprise about 5.0 wt % to about 20 wt % surfactant active, about 5.0 wt % to about 25 wt % total additives, alternatively about 5.0 wt % to about 20 wt % total additives, and about 1×10⁷ to about 1×10¹⁰ CFU/g beneficial microorganisms. In some embodiments, dilutable compositions are preferred as a cost saving and money saving option, which reduces packaging and shipping cost. In some embodiments, the concentrate may be diluted to the working concentration on site and packaged as a ready to use liquid or spray.

The diluent for diluting the concentrate form of the composition can be any diluent system known in the art. Examples of suitable diluents include, but are not limited to, water, glycols (preferably propylene glycol), alcohols (e.g., isopropanol, ethanol, methanol), other polar solvents known in the art, and mixtures thereof. Water is a preferred diluent of the presently described technology, and can be de-ionized water, hard water, soft water, distilled water, tap water or combinations thereof.

As another example of end use, the compositions of the present technology can be combined with microbes to enable use of inhibitory surfactants used in agricultural biocontrol, biofertilizer, biostimulant, bio-pesticide, and bio-fungicide formulations. In agriculture, microorganisms, typically of the spore type and typically of the Bacillus species, are applied to plants and/or fields to help limit growth of pathogenic organisms including fungi, leading to healthier growing crops. Many agricultural applications rely on surfactants to effectively wet leafy surfaces for efficient use of the ingredients carried by the formulation, including microorganisms like Bacillus. However, these agricultural surfactants can adversely affect viability, growth, and/or biological activity of the microorganisms, both in the formulation and end-use relevant concentration state. The additives in the compositions of the present technology can overcome the adverse effects of the surfactant, thereby enabling use of these surfactants in agricultural bio-pesticide and bio-fungicide formulations.

For agricultural applications, the compositions of the present technology are typically formulated as a concentrate, and diluted prior to use at a dilution ratio in the range of 1:2.5 to 1:3200, alternatively 1:100 to 1:1000, alternatively 1:256 to 1:512, and preferably a dilution ratio of 1:400. The concentrate may comprise about 1.0 wt % to about 20 wt % surfactant active, about 1.0 wt % to about 20 wt % total additives, and about 1×10⁶ to about 5×10¹⁰ CFU/g, alternatively about 1×10⁷ to about 1×10¹⁰ CFU/g beneficial microorganisms.

As a further end use example, the compositions of the present technology can be used in environmental remediation applications to enable beneficial microorganisms to remove contaminants from soil. Beneficial microorganisms, such as Bacillus species, can be used to break down chemicals and pollutants in the soil via enzyme and acid generation. Surfactants can be used in conjunction with the bacteria to emulsify the pollutants, particularly hydrocarbons, and make them more bio-available to the bacteria. Rhamnolipids, in particular, are an attractive biosurfactant for use in soil remediation applications due to their favorable biodegradability and low toxicity properties. However, rhamnolipids also have antimicrobial properties and have been found to adversely affect the viability, growth, and/or biological activity of bacteria at surfactant concentrations well below levels useful for soil remediation. The additives in the compositions of the present technology can overcome the adverse effects that rhamnolipids have on the beneficial microorganisms thereby enabling the rhamnolipids to be used with the beneficial microorganisms for soil remediation applications.

The environmental remediation of soil using rhamnolipids and additives of the present technology can be accomplished by applying an aqueous composition comprising rhamnolipids to the soil to be remediated, and applying a composition containing (a) an additive comprising (i) a blend of divalent metal salt and L-amino acid, and (ii) optionally, a carbohydrate, (b) live beneficial microbial spores, and (c) a carrier, to the soil to be remediated. The aqueous composition comprises rhamnolipids in an actives amount of about 0.1 wt % to about 25 wt %, alternatively about 1 wt % to about 20 wt %, alternatively about 5 wt % to about 10 wt %, and can be applied to the soil in an amount in the range of about 1 g per kg of soil to about 200 g per kg of soil, alternatively about 2 g per kg of soil to about 150 g per kg of soil, alternatively about 5 g per kg of soil to about 100 g per kg of soil. The composition containing the additive comprises about 0.1 wt % to about 25 wt %, alternatively about 1 wt % to about 20 wt %, alternatively about 5 wt % to about 10 wt % of the blend of divalent metal salt and L-amino acid, based on the weight of the composition, about 1×10⁶ to about 1×10¹⁰ CFU/g of microbial spores, and carrier to total 100% by weight of the composition. If a carbohydrate is included in the additive, the amount of carbohydrate is preferably not greater than the total weight of divalent metal salt and L-amino acid in the composition. The relative amounts by weight of the divalent metal salt and L-amino acid in the composition can be a weight ratio of L-amino acid to divalent metal salt of 1:1 or greater when carbohydrate is absent, and a weight ratio of divalent metal salt to L-amino acid of 1:1 or greater when carbohydrate is present. In some embodiments, the L-amino acid comprises L-alanine and the divalent metal salt comprises magnesium chloride or a hydrate thereof, and the carbohydrate, when present, comprises glucose. Bioremediation can be carried out using various bacterial, fungal, or algal species or combinations thereof including Bacillus bacteria in spore form. The carrier can be any carrier that is compatible with the microbial spores and is suitable for soil remediation. Water is a suitable carrier for the composition containing the additive. The amount of the composition applied to the soil can be in the range of about 1 g per kg of soil to 200 g per kg of soil, alternatively about 2 g per kg of soil to about 150 g per kg of soil, alternatively about 5 g per kg of soil to about 100 g per kg of soil.

The present technology also includes a method for overcoming surfactant incompatibility between a live beneficial microorganism and a surfactant that adversely affects the viability, growth or biological activity of the live beneficial microorganism. The method involves combining the additives described herein with the surfactant that exhibits the antagonistic surfactant incompatibility and the live beneficial microorganism, wherein the amount of the additive is in a weight ratio of additive (L-amino acid, divalent metal salt and/or monovalent salt) to surfactant of 0.2:1 to 1:1, and the additive overcome the antagonistic surfactant incompatibility and facilitate viability, growth, and biological activity of the beneficial microorganism. In one embodiment of the method, the additives are combined and mixed with an aqueous composition comprising the incompatible surfactant, and the beneficial microorganism is then added to the aqueous composition as a final step. The beneficial microorganism could be added to the aqueous composition at the site of application, or could be pre-mixed with the aqueous composition to form an end product. Alternatively, the beneficial microorganism could be added to the aqueous composition comprising the incompatible surfactant in the absence of the additives, which are then added at a later stage. The absence of additives at the initial mixing of the surfactant and beneficial microorganism ensures the microorganism does not prematurely activate. Addition of the additives to the composition then activates the microorganism to consume soils on and in surfaces, act beneficially on crops, or provide other beneficial properties.

The pH of the composition can be adjusted to a pH of 6-8 if necessary, depending on the choice of incompatible surfactant. Standard mixing equipment can be used to combine the incompatible surfactant, additives and beneficial microorganism. Dispersing the beneficial microorganisms with a portion of the surfactant and additives used in the total composition prior to the mixing can improve efficiency of mixing and dispersity of the beneficial microorganisms.

One skilled in the art will recognize that modifications may be made in the present technology without deviating from the spirit or scope of the invention. The invention is further illustrated by the following examples, which are not to be construed as limiting the invention in spirit or scope to the specific procedures or compositions described therein.

The pH of the compositions was determined at room temperature (20-25° C.) using a calibrated electrode.

For the following Examples 1-3, germination, growth, and biological activity of bacterial spores was evaluated using a dyed extra-virgin olive oil (EVOO) digestion test which is, like the resazurin method, also a limited nutrient liquid suspension test. Because EVOO is a food source for vegetative cells, lightly-dyed EVOO added to a test sample containing bacterial spores can be an indicator of biological activity. Since spores that have germinated and grown into fully functional vegetative cells secrete enzymes that can digest the EVOO, a decrease in the amount of oil over time shows the spores have germinated and grown into vegetative cells that have digested the oil. For the digestion test, 100 g of each test composition is prepared by combining a test surfactant, different amounts of additives, and 1×10⁸ CFU/g Bacillus species mix in spore form from commercial sources. Each test composition also included 0.20 g of 33 g/L Nutrient Mix (30 g/L Tryptic Soy Broth BD211825 and 3 g/L Yeast Extract BD212750 at pH 7.1-7.4). The test composition is mixed, then stored at 37° C. for 2-3 days to condition the spores. After conditioning, 1 g of the test composition is added to a scintillation vial, and a single drop (about 15 mg) of lightly-dyed (Sudan III, 62.5 ppm) EVOO is added to the test sample in the scintillation vial without mixing. The initial oil drop is digitally photographed, and re-photographed after 4 days of gentle swirling on an orbital shaker at a setting of 1-2 on a scale of 0-10. Oil drop sizes are determined by transferring the photographed images to a computer and measuring the major diameter of each oil drop using a Tracker.jar line profile analysis (https://physlets.org/tracker/) to determine the length of the diameter in units of pixels. Oil drop sizes of initial and digested test samples are compared. A decrease in measured drop diameter indicates germination and growth of the bacterial spores and digestion of the EVOO, which indicates that the additives in the test composition have overcome the antagonistic surfactant incompatibility. An increase in measured drop diameter is interpreted as a change in surface tension due to the surfactant, combined with no or minimal EVOO digestion by the bacteria.

Stat-Ease 360 software was used to generate each design of experiment sample group, model the test results from the resulting data, and generate statistics for the optimal models. The models were then used to generate an optimization plot using Stat-Ease 360's Numerical Optimization function. The optimization includes a contour plot of “desirability” of component levels for the defined design space. These plots visually represent the complex relationships between the surfactant and additive components and show where desired performance is high and where it is low or zero.

### EXAMPLES

### Example 1: Formulations with Rhamnolipids and Additives

Test compositions comprising rhamnolipid surfactant and different amounts of additives were prepared as described above to evaluate the ability of the additives to overcome the antagonistic incompatibility between the rhamnolipid surfactant and the bacterial spores. The additives used were L-alanine, magnesium chloride hexahydrate, potassium nitrate, and glucose. The rhamnolipid surfactant is a mixture of mono-rhamnolipids and di-rhamnolipids, in a weight ratio of di-rhamnolipids to mono-rhamnolipids in the range of 55:45 to 56.5:43.5. The mixture includes RhaRha-C10-C10 in an amount in the range of 36%-38% by weight, and Rha-C10-C10 in an amount in the range of 35%-37% by weight, based on the total weight of rhamnolipids in the mixture.

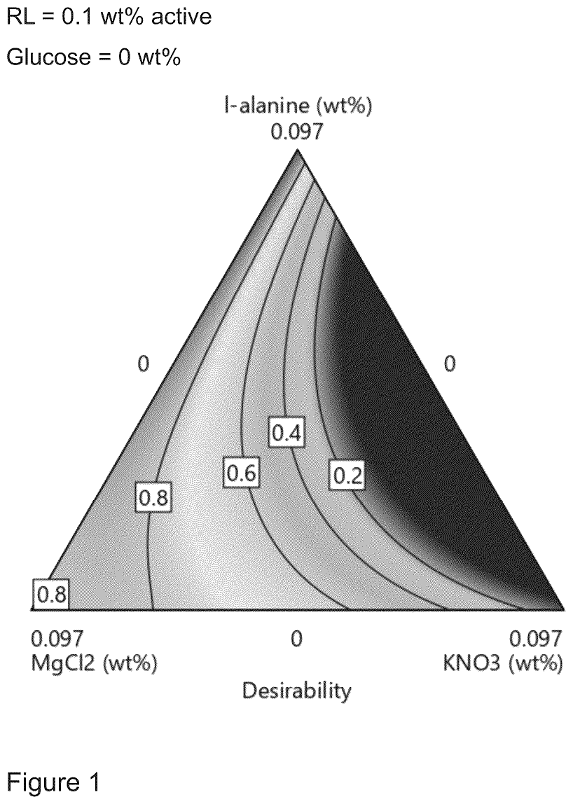

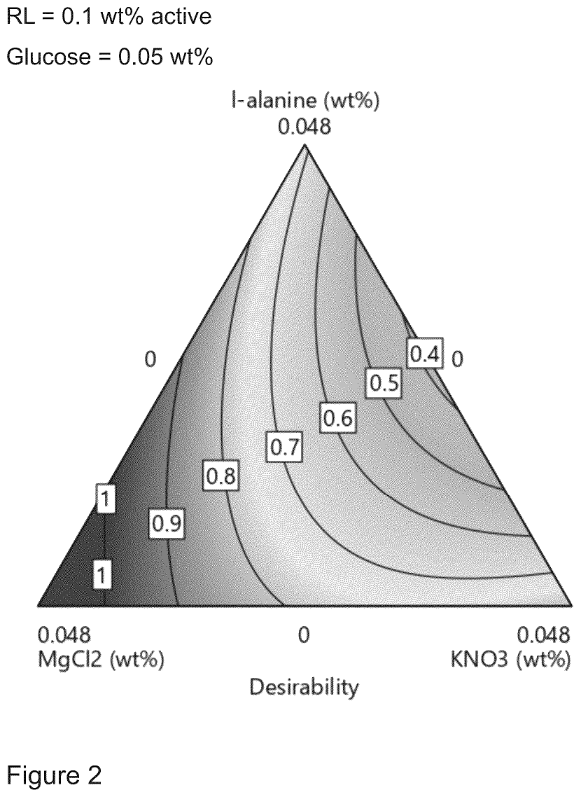

Samples of each of the test compositions were tested for EVOO digestion using the test procedure described above. The EVOO digestion data was used to generate Stat-Ease 360 optimization contour plots for the test compositions without and with glucose as one of the additives. The contour plots for the test compositions without glucose and with glucose as an additive are shown in FIGS. 1 and 2, respectively. The optimization plots show contour lines that depict areas of high desirability and of zero desirability corresponding to different amounts of the different additives. For the contour plot shown in FIG. 1, the areas of high desirability are along the left side of the plot, with a broader area at the lower left corner, and the areas of low desirability are the dark areas on the right side of the plot. The areas of high desirability occur with L-alanine or a blend of L-alanine and magnesium chloride, allowing for a small amount of potassium nitrate to also be included. Adding glucose to the additives changes the areas of desirability, as shown in FIG. 2. For the contour plot shown in FIG. 2, the areas of high desirability are at the bottom left corner of the plot. These areas of high desirability show that, when glucose is present, the additive can comprise higher amounts of magnesium chloride and potassium nitrate, than when glucose is absent. The distinct regions of high to zero desirability show that the amounts and ratios of the particular additives are important for overcoming the antagonistic effect that the rhamnolipid surfactant has on a beneficial microorganism.

### Example 2: Formulations with Alkyl Sarcosinates and Additives

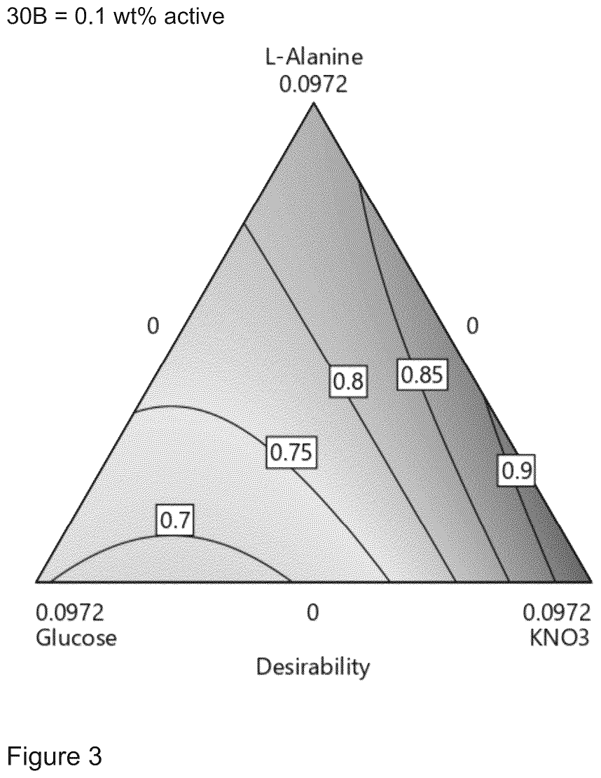

Test compositions comprising an alkyl sarcosinate surfactant and different amounts of additives were prepared as described above to evaluate the ability of the additives to overcome the antagonistic incompatibility between the alkyl sarcosinate surfactant and the bacterial spores. The additives used were L-alanine, potassium nitrate, and glucose. Magnesium chloride hexahydrate was not used in this Example, since magnesium chloride and alkyl sarcosinate can co-precipitate. The alkyl sarcosinate was MAPROSYL® 30-B, a sodium lauroyl sarcosinate, available from Stepan Company, Northfield, Illinois. Samples of each of the test compositions were tested for EVOO digestion using the test procedure described above, and contour plots were generated from the test data. The Stat-Ease 360 optimization contour plot for the test compositions is shown in FIG. 3. The optimization plot shows contour lines that depict areas of high desirability and of zero desirability corresponding to different amounts of the different additives. For the contour plot shown in FIG. 3, the areas of high desirability are the darker areas on the right side of the plot. These areas of high desirability occur with potassium nitrate and/or L-alanine as the additives, although small amounts of glucose can also be included. The distinct regions of high to zero desirability show that the amounts and ratios of the particular additives are important for overcoming the antagonistic effect that the alkyl sarcosinate surfactant has on a beneficial microorganism.

### Example 3: Formulations with Alpha-Sulfonated Alkyl Esters and Additives

Test compositions comprising alpha-sulfonated alkyl esters and different amounts of additives were prepared as described above to evaluate the ability of the additives to overcome the antagonistic incompatibility between the alpha-sulfonated alkyl esters surfactant and the bacterial spores. The additives used were L-alanine, magnesium chloride hexahydrate, potassium nitrate, and glucose. The alpha-sulfonated alkyl ester surfactant is ALPHA-STEP® PC-48, sodium methyl-2-sulfolaurate and di-sodium methyl-2-sulfolaurate, available from Stepan Company, Northfield, Illinois.

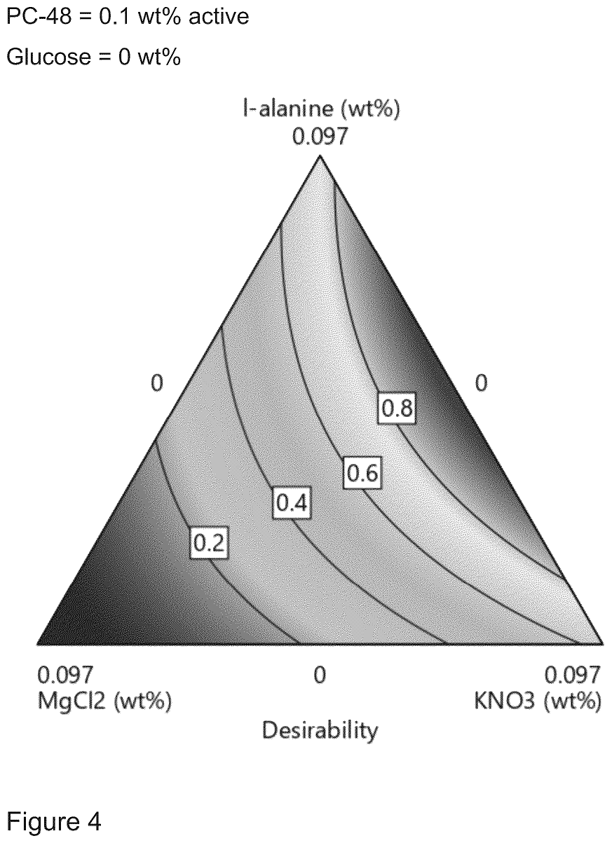

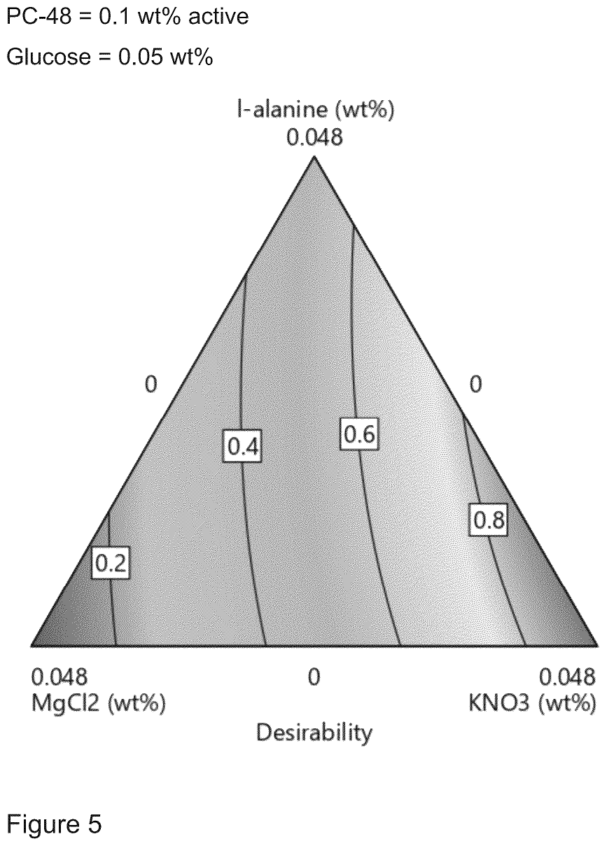

Samples of each of the test compositions were tested for EVOO digestion using the test procedure described above, and contour plots were generated from the test results. The Stat-Ease 360 optimization contour plots for the test compositions without and with glucose as one of the additives are shown in FIGS. 4 and 5, respectively. The optimization plots show contour lines that depict areas of high desirability and of zero desirability corresponding to different amounts of the different additives. For the contour plot shown in FIG. 4, the areas of high desirability are along the right side of the plot, and the dark area at the lower left corner of the plot indicates an area of zero desirability. The areas of high desirability occur with potassium nitrate and/or L-alanine as the additive, and the area of zero desirability occurs with magnesium chloride as the additive. Including glucose in the additive changes the areas of desirability, as shown in FIG. 5. When glucose is present in the additive, the areas of high desirability are at the lower right corner of the plot and occur when the additive comprises mostly potassium nitrate, whereas areas of low to zero desirability occur when L-alanine and magnesium chloride are included in the additive. The distinct regions of high to zero desirability show that the amounts and ratios of the particular additives are important for overcoming the antagonistic effect that the alpha-sulfonated alkyl ester surfactant has on a beneficial microorganism.

For the following Examples 4-7, germination and growth of bacterial spores were visually evaluated using an un-dyed EVOO test. For the test, each test composition was prepared by adding 0.1 wt % un-dyed EVOO to a test jar containing an aqueous solution of the test formulation comprising surfactant in an amount of 0.2 wt % active, total additives of 0.2 wt % and 1×10⁷ CFU/g Bacillus species mix in spore form from commercial sources. The test additives used in each test formulation comprised 0.09 wt % L-alanine, 0.09 wt % potassium nitrate, and 0.02 wt % magnesium chloride hexahydrate. Comparative compositions were also prepared comprising the surfactant and bacterial spores, but no additive. Control compositions contained the bacterial spores, with and without additives, but no surfactant. All test, comparative and control compositions contained 2 wt % of 3.3 g/L Nutrient Mix. The pH was adjusted to pH of 7 if needed, using L-lactic acid or dilute NaOH. The compositions were photographed initially, then re-photographed after 4 and 5-7 days of orbital-mixer shaking at setting “5”, and initial and aged compositions were compared visually to determine differences.

### Example 4: Formulations with Alcohol Ethoxylates and Additives

Test formulations were prepared comprising different mid-HLB range (HLB=12-14) alcohol ethoxylate surfactants in an amount of 0.2 wt % active, and the additive composition described above, i.e. 0.09 wt % L-alanine, 0.09 wt % potassium nitrate, and 0.02 wt % magnesium chloride hexahydrate. The alcohol ethoxylate surfactants tested were MAKON® UD-7, a 7-mole ethoxylated branched undecyl alcohol, MAKON® DA-6, a 6-mole ethoxylated decyl alcohol, and BIO-SOFT® N1-7, a 7-mole ethoxylated semi-linear undecyl alcohol, all available from Stepan Company, Northfield, Illinois. Comparative formulations that did not contain the additives were also prepared for each surfactant. The formulations were evaluated for germination and growth of bacterial spores using the un-dyed EVOO procedure described above.

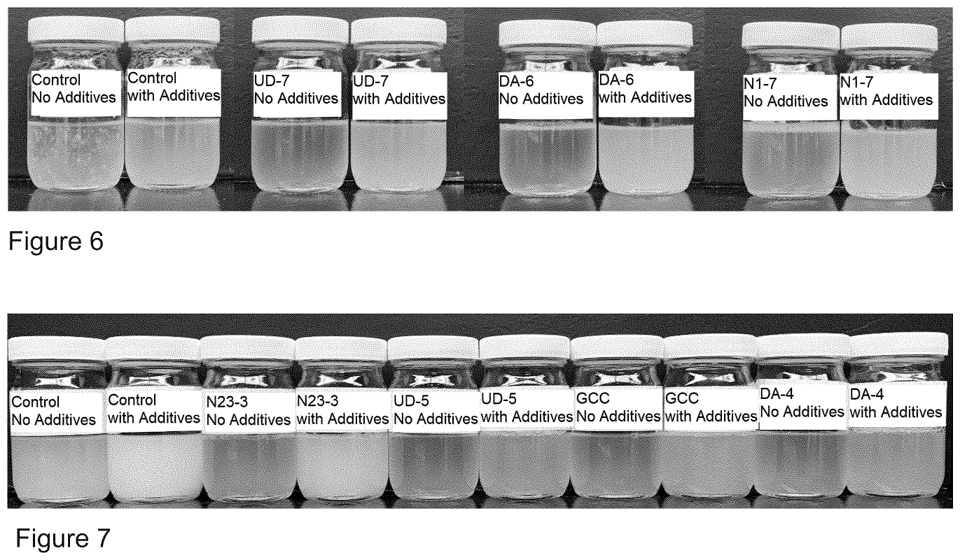

FIG. 6 is a photograph showing the test composition jars with and without the additives after 7 days of shaking on the orbital mixer. Also shown in the photograph are the control composition jars containing the bacterial spores with and without additives and no surfactant. Haze in the test jars indicates biological activity, and more haze represents greater biological activity. The control compositions are the left-most pair in FIG. 6, with the jar on the left containing just the spores, and the jar on the right containing the additives in addition to the spores. A comparison of the control jars shows that, even without the surfactant, the additives provide a benefit by providing an improved degree of dispersion and lack of agglomeration of the bacterial spores.

For the surfactant-containing formulations without additives (left-side jar of each pair), all are inhibitive to biological activity, hazy only due to the initial population of Bacillus. The degree of haze for these jars is a good visual ruler for 1×10⁷ CFU/g Bacillus. With additives (right-side jar of each pair), the surfactant inhibition is overcome, with good biological activity and stronger visual haze. It is important to note that biological activity haze can be distinguished from surfactant haze based on timing of appearance. Surfactant haze appears nearly immediately upon formulation, whereas biological activity haze takes a minimum of 12 hours to appear, more typically 48-96 hours, and can continue to grow with time. The appearance of haze is a visual indicator that the additive in the test formulation has overcome the surfactant incompatibility.

### Example 5: Formulations with Low-HLB Surfactants and Additives

Test formulations were prepared comprising different low-HLB surfactants (HLB=5-10) in an amount of 0.2 wt % active, and the additive composition described above, i.e. 0.09 wt % L-alanine, 0.09 wt % potassium nitrate, and 0.02 wt % magnesium chloride hexahydrate. The low-HLB surfactants tested were BIO-SOFT® N23-3, a C12-13 semi-linear alcohol ethoxylate with 3 moles of ethylene oxide, MAKON® UD-5, a 5-mole ethoxylated branched undecyl alcohol, STEPAN-MILD® GCC, glyceryl caprylate/caprate, and MAKON® DA-4, a branched 4-mole ethoxylated decyl alcohol, all available from Stepan Company, Northfield, Illinois. The initial haze in the test formulations was partially clarified by adding 1.0 wt % castor oil ethoxylate containing 36 moles of ethylene oxide to the test formulations. The formulations were evaluated for germination and growth of bacterial spores using the un-dyed EVOO procedure described above.

FIG. 7 is a photograph showing the test jars with additives (right jar in each pair) and without the additives (left jar in each pair) after 5 days of shaking on the orbital mixer. Also shown in the photograph are the control composition jars (left-most pair) containing the bacterial spores with additives (right jar) and without additives (left jar) and no surfactant. The increase of haze due to biological activity is evident in the photograph for the control jars and the surfactant test jars with additives. The no-additives surfactant test jars show strong inhibition of the Bacillus, being much clearer with visual haze similar to that of the initial Bacillus population only. The presence of the additives in the test formulations assists these low-HLB surfactant to overcome their otherwise inhibitory action on the Bacillus spores.

### Example 6: Formulations with Dispersants and Additives

Test formulations were prepared comprising different dispersants in an amount of 0.2 wt % active, and the additive composition described above, i.e. 0.09 wt % L-alanine, 0.09 wt % potassium nitrate, and 0.02 wt % magnesium chloride hexahydrate. Dispersants are specific classes of surfactants that can keep particles separated from each other, aiding physical stability of compositions. The dispersants tested were STEP-FLOW® 26F, an EO/PO block copolymer, STEPFAC® 8181 PT3K, phosphate ester salts, and STEPWET® DOS 60 ROE, a sodium dioctyl sulfosuccinate with rapeseed oil methyl ester, all available from Stepan Company, Northfield, Illinois. The formulations were evaluated for germination and growth of bacterial spores using the un-dyed EVOO procedure described above.

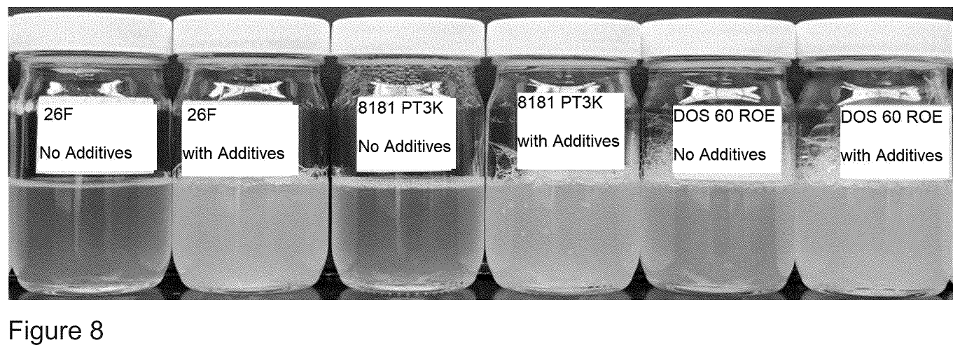

FIG. 8 is a photograph showing the test jars with additives (right jar in each pair) and without the additives (left jar in each pair) after 7 days of shaking on the orbital mixer. Both the STEP-FLOW® 26F EO/PO block copolymer and the STEPFAC® 8181 PT3K phosphate ester salts are strongly inhibitive of biological activity, as shown by the lack of haze in the comparative formulations not containing the additives. However, the test formulations containing the additives show significant haze, indicative of biological activity. The additives in the test formulations assists these dispersants in overcoming their otherwise inhibitory action on the Bacillus spores. For the DOS 60 ROE sodium dioctyl sulfosuccinate with rapeseed oil methyl ester, 0.8 wt % active STEPANATER SXS sodium xylene sulfonate was added as a hydrotrope to bring the initially formulated composition to sufficient clarity to monitor for biological activity. The slightly greater visual haze for this formulation without additives may simply be due to the methyl ester not being fully solubilized.

### Example 7: Formulation with Hydroxysultaine and Additives

Test formulations were prepared comprising hydroxysultaine surfactant in an amount of 0.2 wt % active, and the additive composition described above, i.e. 0.09 wt % L-alanine, 0.09 wt % potassium nitrate, and 0.02 wt % magnesium chloride hexahydrate. The hydroxysultaine was AMPHOSOL® CS-50, cocoamidopropyl hydroxysultaine, available from Stepan Company, Northfield, Illinois. The formulations were evaluated for germination and growth of bacterial spores using the un-dyed EVOO procedure described above.

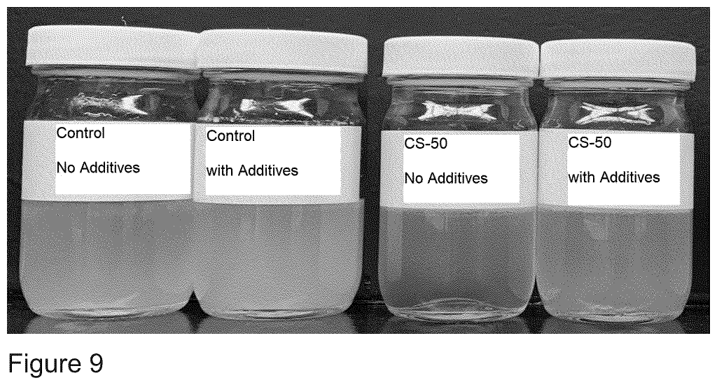

FIG. 9 is a photograph showing the test jars with additives (right jar) and without the additives (left jar) after 7 days of shaking on the orbital mixer. The control jars are on the far left. The AMPHOSOL® CS-50, cocoamidopropyl hydroxysultaine inhibits biological activity, as shown by the lack of haze in the comparative formulation not containing the additives. However, the test formulation containing the additives shows haze, indicative of biological activity. The additives in the test formulation assists the hydroxysultaine surfactant in overcoming the otherwise inhibitory action on the Bacillus spores.

### Example 8: EVOO Digestion and Stability Assessment

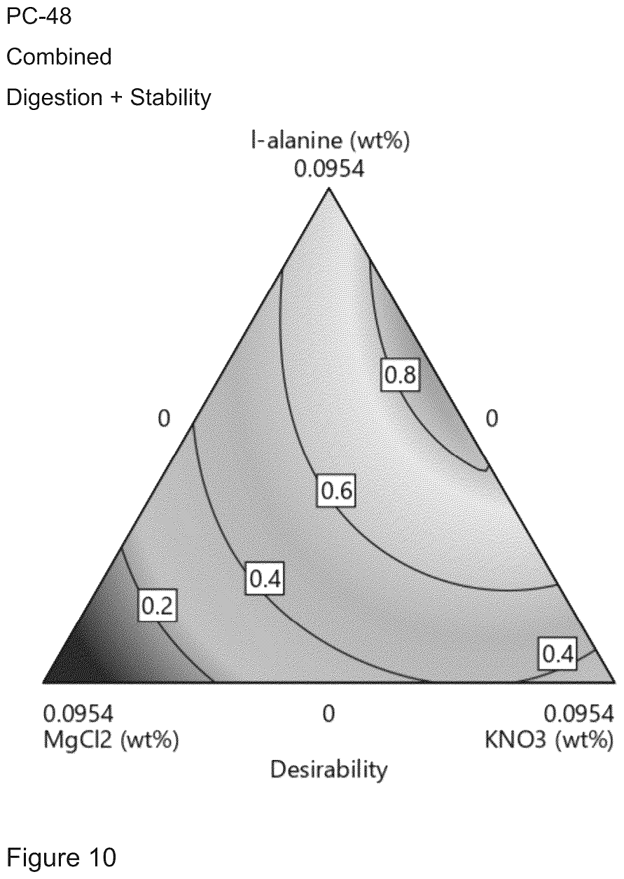

The alpha sulfonated alkyl ester test compositions from Example 3 were used for this stability assessment because, unexpectedly, the spores in some of the test compositions remained fully dispersed in the compositions after sitting for 1 week, even though the test compositions were at use dilution and water thin. Physical stability of the test compositions was assessed by photographing the test compositions in the parent sample jars (from which the Example 3 samples were taken), looking down on the sample jars, and quantifying the degree of precipitation via Tracker.jar image analysis. A contour plot combining the digestion results from Example 3 and the physical stability test results from this Example was generated to determine compositions that exhibit both good biological activity and good spore stability. The contour plot is shown in FIG. 10. The areas of higher desirability are shown along the right side of the plot, and an area of zero desirability is the darker area shown in the lower left corner of the plot. The areas of higher desirability, demonstrating both good biological activity and good stability, occur with potassium nitrate and L-alanine as the additives, but tend toward a higher amount of L-alanine.

### Example 9: Comparative Formulations with Alpha-Sulfonated Alkyl Esters and Additives

A test was conducted to compare compositions comprising alpha sulfonated alkyl esters and different amounts of additives. The contour plot in FIG. 4 shows that the areas of high desirability are along the right side of the plot and occur when potassium nitrate and/or L-alanine is the additive, with minimal or no magnesium chloride hexahydrate present, whereas the areas of poor desirability are at the lower left corner of the plot and occur when the additive composition contains higher amounts of magnesium chloride hexahydrate. Five comparative compositions were prepared as described for Examples 1-3, with 0.10 wt % ALPHA-STEP® PC-48 as the alpha sulfonated alkyl ester surfactant and the additives comprising 0.07 wt % MgCl₂-6H₂O+0.015 wt % L-Alanine+0.015 wt % KNO₃. Five test compositions were similarly prepared except the additives comprised 0.045 wt % L-Alanine+0.045 wt % KNO₃+0.01 wt % MgCl₂-6H₂O. Germination and growth of bacterial spores were visually evaluated using the un-dyed EVOO test described above for Examples 4-7.

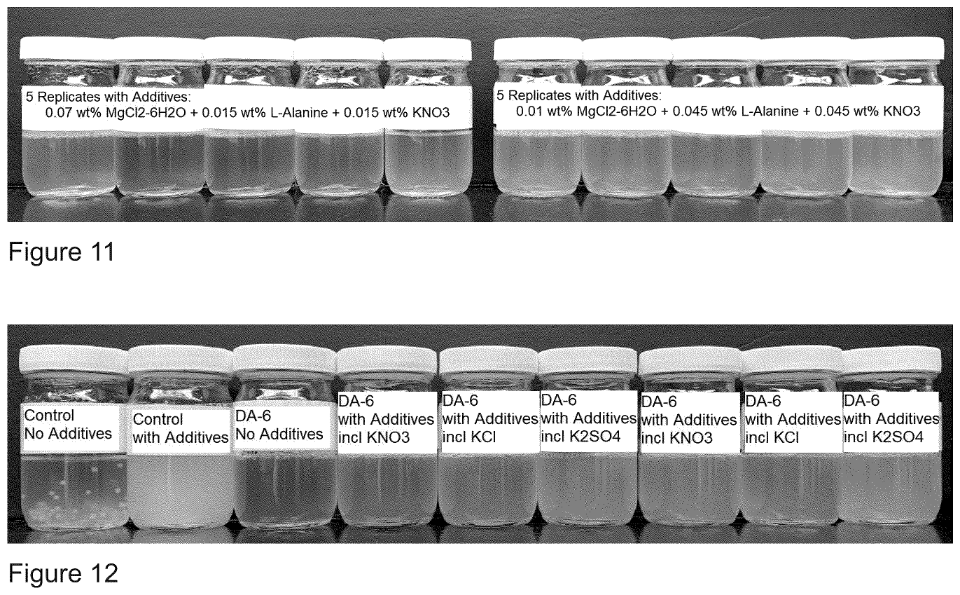

FIG. 11 shows the results after 7 days on the orbital shaker at room temperature. The left 5 jars, containing the comparative compositions, show minimal haze, indicating minimal biological activity. The comparative compositions demonstrate the inhibitive nature of the alpha sulfonated alkyl ester surfactant and the inability of the additives composition containing a higher amount of MgCl₂-6H₂O to overcome it. The 5 jars on the right, containing the test compositions, show that the additives comprising higher amounts of potassium nitrate and L-alanine with a minimal amount of MgCl₂-6H₂O are able to restore biological activity, as demonstrated by the haziness of the aqueous phase visible in these jars. The results show that the amounts and ratios of the particular additives are important for overcoming the antagonistic effect that the alpha-sulfonated alkyl ester surfactant has on a beneficial microorganism.

### Example 10: Formulations Comparing Alternative Potassium Salts as Additives

This example compares alternative potassium salts to determine whether salts other than KNO₃ can be used in the additives composition. Replicate aqueous test formulations were prepared using MAKON® DA-6 as the surfactant, in an amount of 0.2 wt % active, and the additive composition comprised 0.09 wt % L-alanine, 0.09 wt % of potassium salt, and 0.02 wt % magnesium chloride hexahydrate. The potassium salts tested were KNO₃, KCl, and K₂SO₄. A comparative composition was also prepared comprising the surfactant and bacterial spores, but no additive. Control compositions contained the bacterial spores, with and without additives, but no surfactant to confirm the viability of the spores. KNO₃ was used as the potassium salt in the control composition containing additives. All test, comparative, and control compositions contained 2 wt % of 3.3 g/L Nutrient Mix. The pH was adjusted to pH of 7 if needed, using L-lactic acid or dilute NaOH. Germination and growth of bacterial spores were visually evaluated using the un-dyed EVOO test described above for Examples 4-7. The compositions were photographed after 7 days of orbital-mixer shaking at setting “5” at room temperature.

FIG. 12 shows the results after 7 days on the orbital shaker. The left-most jar in the photograph is the control formulation without additives or surfactant, and the second jar from the left is the control formulation with additives, but no surfactant. FIG. 12 shows that, without the additives, spores in the left-most control jar agglomerate and are not well-dispersed. The presence of the additives encourages more biological activity and maintains excellent dispersion of the spores, as seen in the control jar second from the left. The strongly inhibitive action of MAKON® DA-6 is observed in the jar 3rd from the left that shows minimal biological activity in the absence of the additives. The remaining jars in the photograph contained the test formulations with the additives. The right-most set of 3 jars contained KNO₃, KCl, and K₂SO₄, in that order, as the potassium salt. The set of 3 jars just to the left of the set of 3 on the far right is a replicate set, which demonstrates the repeatability of the test. Each of the potassium salts help overcome the inhibitive action of the MAKON® DA-6 surfactant and restores biological activity, as demonstrated by the haziness of the aqueous phase visible in these jars. The results show that potassium salts other than KNO₃ can be used in the additives composition, and that potassium sulfate may promote the most biological activity.

### Example 11: Formulations with Alternative Magnesium Salts

This example compares alternative magnesium salts to determine whether salts other than MgCl₂ can be used in the additives composition. Replicate test formulations were prepared using rhamnolipids as the surfactant, in an amount of 0.2 wt % active, and the additive composition comprised 0.03 wt % L-alanine, 0.03 wt % of potassium nitrate, and 0.14 wt % magnesium salt. The magnesium salts tested were MgCl₂-6H₂O, MgNO₃, MgSO₄, and Mg(Citrate) (dibasic). Control compositions were also prepared with one control composition containing bacterial spores and additive but no surfactant, and the other control composition containing the surfactant and bacterial spores, but no additive. The test and control compositions also contained 2 wt % of 3.3 g/L Nutrient Mix. The pH was adjusted to pH of 7 if needed, using L-lactic acid or dilute NaOH. Germination and growth of bacterial spores were visually evaluated using the un-dyed EVOO test described above for Examples 4-7. The compositions were photographed after 7 days of orbital-mixer shaking at setting “5” at room temperature.

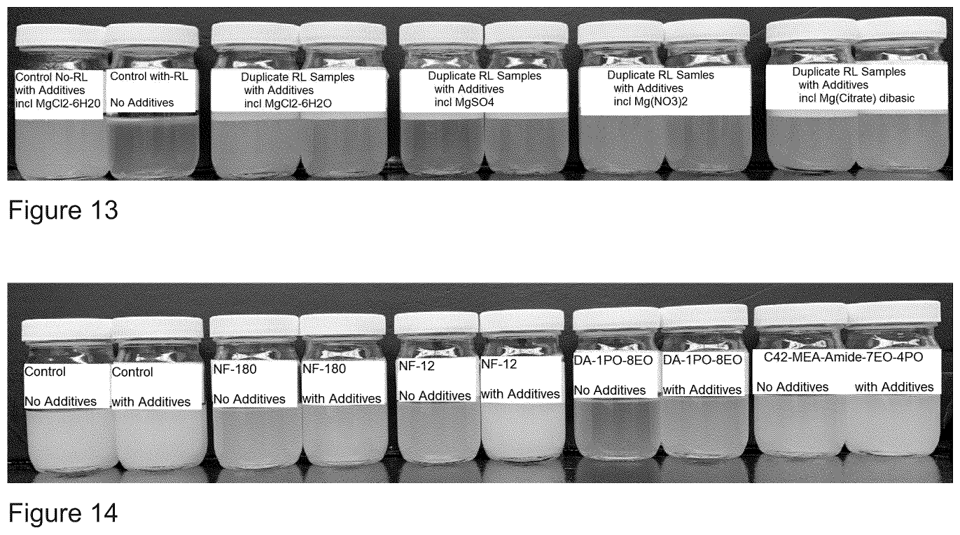

FIG. 13 shows the results after 7 days on the orbital shaker. The left-most jar in the photograph is the control formulation with the MgCl₂-6H₂O based additives composition without rhamnolipid surfactant, and the second jar from the left is the control formulation with rhamnolipid surfactant but no additives. The control formulations demonstrate the viability of the spores and the inhibitory effect of the rhamnolipid surfactant. The remaining jars in the photograph contained the test formulations with rhamnolipid surfactant with the additives containing the various Mg salts. The jars from left to right next to the control jars contain duplicate formulation pairs, with each formulation pair containing MgCl₂-6H₂O, MgSO₄, Mg(NO₃)₂ or Mg(Citrate) dibasic, in that order, as the magnesium salt. Each of the magnesium salts help overcome the inhibitive action of the rhamnolipid surfactant and restore biological activity, as demonstrated by the haziness of the aqueous phase visible in these jars. The results show that magnesium salts other than MgCl₂-6H₂O can be used in the additives composition.

### Example 12: Formulations with Low Foam Nonionic Alkoxylates and Additives

An important class of nonionic alkoxylates is a group known as alkylene oxide-containing alcohol alkoxylates. Alkylene oxide includes not only ethylene oxide (EO), but also propylene oxide (PO), butylene oxide (BO), or even pentylene oxide (PTO). These alkoxylates can provide extra grease cleaning with low foaming if the alkoxylation extends the alkyl chain slightly. If more PO is utilized, the HLB lowers and foaming decreases, making the surfactants useful for low-foam mechanical washing. Test formulations were prepared comprising different low foam nonionic alkoxylated surfactants in an amount of 0.2 wt % active, and the additive composition comprised 0.09 wt % L-alanine, 0.09 wt % potassium nitrate, and 0.02 wt % magnesium chloride hexahydrate. The low foam nonionic alkoxylated surfactants tested were MAKON® NF-180 (proprietary alkoxylated polymer), MAKON® NF-12 (C10-12 alcohol alkoxylate), DA-1PO-8EO (isodecyl-1PO-8EO), and C42 MEA Amide-7EO-4PO (C12-C14 monoethanolamide-7EO-4PO), all MAKON® trade-name materials available from Stepan Company, Northfield, Illinois, the other two being experimental materials. The surfactants were solubilized in the aqueous formulations by adding 1.0 wt % castor oil ethoxylate containing 36 moles of ethylene oxide (TOXIMUL® 8240) to the test formulations. Comparative compositions were also prepared comprising each surfactant, 1.0 wt % TOXIMUL® 8240 solubilizer, and bacterial spores, but no additive. Control compositions were prepared, with one composition comprising the bacterial spores without surfactants or additives, and the other comprising spores and additives but no surfactant. In this example, the control jars also contain 1.0 wt % TOXIMUL 8240 solubilizer. All test, comparative, and control compositions contained 2 wt % of 3.3 g/L Nutrient Mix. The pH was adjusted to pH of 7 if needed, using L-lactic acid or dilute NaOH. Germination and growth of bacterial spores were visually evaluated using the un-dyed EVOO test described above for Examples 4-7.

FIG. 14 is a photograph of the results after 7 days of shaking on the orbital mixer. Each alkoxylate is shown in pairs, where the left-most jar of each pair contains the respective alkoxylate without additives, and the right-most jar of each pair includes the additives. Also shown in the photograph are the control composition jars (left-most pair) containing the bacterial spores with additives (right jar) and without additives (left jar) and no surfactant, only the 1 wt % TOXIMUL® 8240 solubilizer. The test formulations containing MAKON® NF-180 are next to the control pair, followed by the formulations containing MAKON® NF-12, then DA-1PO-8EO, and on the far right, the formulations containing C42 MEA Amide-7EO-4PO. Most of these alkoxylates are not as inhibitive of Bacillus growth as the alcohol alkoxylates tested in Example 4, as is evident from the presence of haze due to biological activity even in the test composition jars without additives. The formulation containing DA-1PO-8EO and no additives shows the most sign of inhibition. All the test formulations show increased biological activity with the presence of the additives. The additives can assist even when conditions are not as inhibitive. It also appears from the photograph that the amount of biological activity (haziness) is more than typical, indicating that the TOXIMUL® 8240 may be encouraging more germination and early growth of the Bacillus microorganism.

### Example 13: Use of Rhamnolipids and Additives for Bioremediation (Prophetic)

10 liters of 10% active solution of rhamnolipid in freshwater are prepared. This solution is applied by spraying onto a 1 metric ton pile of soil that includes Bacillus spores. In parallel, another pile of 1 metric ton of untreated soil is set aside for analysis. 1 kg of ammonium chloride (source of nitrogen) is added to both piles of soil. 10 liters of an additive composition is also added to the treated soil. The additive composition comprises 10% by weight of a mixture of L-alanine and magnesium chloride hexahydrate in a weight ratio of 1:1 in water. Samples of the soil from both piles are taken before treatment, and 20, 40, and 70 days after treatment. Total Petroleum Hydrocarbon (TPH) is measured in all samples using Gas Chromatography with Flame Ionization detection (GC/FID system following EPA 8015C). The treated soil displays lower TPH compared to the untreated soil.

### Example 14: Crude Oil Digestion

This example examined the ability of Bacillus species mix in spore form to germinate, grow, and digest West Texas Intermediate (WTI) crude oil when the spores are in an aqueous composition comprising rhamnolipids and additives. Replicate samples were prepared by combining 44.6 g DI water, 0.2 g L-Alanine, 0.2 g MgCl₂-6H₂O, 2.0 g rhamnolipids, 0.5 g Toximul 8240, 2.0 g 33 g/L Nutrient Mix, and 0.5 g of Stock suspension of 10\hat{ }9 CFU/g Bacillus species mix in spore form, and adding 2.0 g WTI Crude Oil on top (“all at once” samples). The samples were mixed at 500 rpm on identical stir plates for 15-30 minutes, allowed to phase separate, and then photographed. The samples were then stirred for 3 days, allowed to phase separate, and re-photographed.

A second set of replicate samples were prepared with the same components and amounts, except the additives, nutrients, and Bacillus species mix in spore form were added sequentially after pre-emulsifying the water, rhamnolipids, TOXIMUL® 8240, and WTI crude oil (“sequential addition” samples). The second set of samples were prepared by mixing the water, rhamnolipids, TOXIMUL® 8240, and WTI crude oil for 15-30 minutes. The samples were allowed to phase separate, and then photographed. The samples were stirred for 3 days to pre-emulsify the WTI crude oil with the rhamnolipids and TOXIMUL® 8240. The samples were allowed to phase separate and then re-photographed. The additives, nutrients, and Bacillus species mix in spore form were then added to the samples and the samples were stirred for 4 days, after which the samples were allowed to phase separate and were photographed.

The results show that the Bacillus species mix in spore form in both the “all at once” samples and the “sequential addition” samples were able to germinate, grow, and digest the WTI crude oil. The results also show that pre-emulsifying the rhamnolipids, TOXIMUL® 8240 and WTI crude oil, followed by the addition of the additives, nutrients, and Bacillus species can improve the digestion of the WTI crude oil.

### Example 15: Formulation with Alkyl Ether Sulfate

A test formulation comprising alkyl ether sulfate (STEOL® 23-2s.70 CP, sodium laureth sulfate, 2 moles of ethoxylate, available from Stepan Company) as the surfactant was prepared. Alkyl ether sulfates are relevant surfactants for use in agricultural compositions, but are incompatible with beneficial microorganisms at concentrations typically used in agricultural formulations. One difficulty in formulating agricultural compositions is that it is often requested that the compositions contain ingredients suitable for Organic Materials Review Institute (OMRI). Potassium nitrate, magnesium chloride, and L-alanine, used as the additives in many of the examples above, are not listed as suitable for OMRI. An alternative additive comprising ingredients listed as suitable was therefore used in this example. The alternative additive comprised a mixture of magnesium nitrate and potassium chloride salts, but no L-amino acid.

Concentrates of two test formulations were prepared comprising the alkyl ether sulfate surfactant at 7.5 wt % actives, a Bacillus spore blend at 10.0 wt % (5×10⁹ CFU/g), a mixture of 0.75 wt % potassium chloride and 0.75 wt % magnesium nitrate, and water to total 100%. Castor oil 36EO alkoxylate (TOXIMUL® 8240) (100% active) in an amount of 1.5 wt % was added to one of the test formulations. Two comparative concentrate compositions were also prepared. One comparative composition comprised the same amount of surfactant and spores but no additive or TOXIMUL® 8240, and the other comparative composition comprised the same amount of surfactant, spores, and TOXIMUL® 8240, but no additive. A total of 20 g of each concentrate composition was prepared.

For the test, each concentrate composition was diluted to 2.0 wt % (1×10⁸ CFU/g) in a 4 oz glass jar, with 1 wt % 33 g/L Nutrient (30 g/L Tryptic Soy Broth+3 g/L Yeast Extract), 0.2 wt % Extra Virgin Olive Oil (EVOO), and water to total 50.0 g total weight. The jars were mixed on the orbital shaker for 15-30 minutes and initially photographed, and then mixed on the orbital shaker for 7 days and re-photographed.

The photographed results showed the comparative compositions (without additive and TOXIMUL® 8240, and without additive) had a lack of haze after 7 days, indicating the alkyl ether sulfate inhibits biological activity of the spores. The lack of haze in the comparative composition with just TOXIMUL® 8240 added to the 7.5 wt % alkyl ether sulfate is surprising because the use of TOXIMUL® 8240 in the test and control formulations in Example 12 gave different results for low foam alkoxylate surfactants. In Example 12, the results showed that the TOXIMUL® 8240 solubilizer may have encouraged more germination and early growth of the Bacillus microorganism since the amount of haziness observed in the Example 12 compositions was more than typical.

The photographed results in this Example also showed that the test composition with just the additive and no TOXIMUL® 8240 had a lack of haze after 7 days, indicating the particular combination of salts used as the additive was not sufficient to overcome the incompatibility between the alkyl ether sulfate and the Bacillus spores. The test composition comprising both the additive and the TOXIMUL® 8240 showed an increase in haze after 7 days, indicating the combination of the additive and TOXIMUL® 8240 solubilizer can overcome the incompatibility between the alkyl ether sulfate surfactant and the spores.

### Example 16: Formulation with Alkyl Benzene Sulfonate

Alkyl benzene sulfonates are another type of surfactant relevant for use in agricultural compositions, but which are also incompatible with beneficial microorganisms at concentrations typically used in agricultural formulations. Four different test formulations were prepared to assess the ability of different amounts of the additive components to overcome the incompatibility between an alkyl benzene sulfonate surfactant and the microbial spores. The test formulations comprised calcium alkyl benzene sulfonate (NINATE® 100 L, available from Stepan Company) as the surfactant, and the following as the different additive components: (1) 1.0 wt % L-Alanine+0.25 wt % each of KCl and Mg(NO₃)₂; (2) 1.0 wt % KCl and 0.25 wt % each of L-alanine and Mg(NO₃)₂; (3) 1.0 wt % Mg(NO₃)₂ and 0.25 wt % each of L-alanine and KCl; and (4) 0.5 wt % of each of L-alanine, Mg(NO₃)₂, and KCl.

Concentrates of the four test formulations were prepared comprising the calcium alkyl benzene sulfonate surfactant at 7.5 wt % actives, a Bacillus spore blend at 10.0 wt % (5×10⁹ CFU/g), 1.5 wt % of the respective additive mixture, and water to total 100%. Each concentrate was 20 g total weight. Two control concentrates were also prepared. The positive control concentrate contained 10 wt % of the Bacillus spore blend and water, and the negative control concentrate contained 10 wt % of the Bacillus spore blend, 7.5 wt % surfactant actives, and water.

For the test, each concentrate composition was diluted to 2.0 wt % (1×10⁸ CFU/g) in a 4 oz glass jar, with 1 wt % 33 g/L Nutrient (30 g/L Tryptic Soy Broth+3 g/L Yeast Extract), 0.2 wt % Extra Virgin Olive Oil (EVOO), and water to total 50.0 g total weight. The jars were mixed on the orbital shaker for 15-30 minutes and initially photographed, and then mixed on the orbital shaker for 7 days and re-photographed.

The photographed results showed variable initial haziness in the sample jars partially due to the dispersed EVOO, the spores, and the solubility of the surfactant itself. The photographed results after 7 days showed an increased amount of haziness in the positive control jar, indicating viability of the spores, and reduced haziness in the negative control jar, demonstrating the incompatibility of the surfactant and the spores. The photographed results also showed some increase in haze after 7 days for each test composition containing either L-alanine or Mg(NO₃)₂ as the majority additive component, and the test composition containing equal amounts of the additive components. The increased haze indicates these particular additive mixtures can, at least to some extent, overcome the antagonistic effect that calcium alkyl benzene sulfonate surfactant has on a beneficial microorganism.

The embodiments and examples described here are illustrative, and do not limit the presently described technology in any way. The scope of the present technology described in this specification is the full scope defined or implied by the claims. Additionally, any references noted in the detailed description section of the instant application are hereby incorporated by reference in their entireties, unless otherwise noted.

Additional embodiments of the invention are described in the following numbered paragraphs.

Paragraph 1. A composition that overcomes antagonistic surfactant incompatibility between a surfactant and a live beneficial microorganism, wherein the surfactant incompatibility adversely affects viability, growth, or biological activity of a live beneficial microorganism, the composition comprising (a) at least one surfactant that exhibits antagonistic surfactant incompatibility when in contact with a live beneficial microorganism and adversely affects viability, growth, or biological activity of the live beneficial microorganism; (b) an additive comprising (i) at least one L-amino acid in combination with at least one of inorganic divalent metal salts or monovalent salts, and (ii) optionally, one or more carbohydrates comprising glucose, maltose, galactose, fructose, sucrose, lactose, molasses, glycogen, or glucans; and (c) water to total 100 wt % of the composition, wherein, the additive is present in the composition in an amount such that the weight ratio of additive component (i) to surfactant in the composition is in the range of 0.2:1 to 1:1, and the additive overcomes the antagonistic surfactant incompatibility between the at least one surfactant and the live beneficial microorganism, and facilitates viability, growth, and biological activity of the beneficial microorganism when the composition is combined with the live beneficial microorganism.

Paragraph 2. A method for overcoming antagonistic surfactant incompatibility between a surfactant and a live beneficial microorganism, wherein the surfactant incompatibility adversely affects viability, growth, or biological activity of a live beneficial microorganism, the method comprising: providing an aqueous composition comprising (a) at least one surfactant that exhibits antagonistic surfactant incompatibility when in contact with a live beneficial microorganism and adversely affects viability, growth, or biological activity of the live beneficial microorganism; combining an additive (b) with the at least one surfactant in the aqueous composition, wherein the additive comprises: (i) at least one L-amino acid in combination with at least one of inorganic divalent metal salts or monovalent salts; and (ii) optionally, one or more carbohydrates comprising glucose, maltose, galactose, fructose, sucrose, lactose, molasses, glycogen, or glucans, wherein the additive is added in an amount to provide a weight ratio of additive component (i) to surfactant of 0.2:1 to 1:1; and combining the live beneficial microorganism with the at least one surfactant in the aqueous composition either before the additive is combined with the at least one surfactant or after the additive is combined with the at least one surfactant; wherein the additive overcomes the antagonistic surfactant incompatibility between the at least one surfactant and the live beneficial microorganism, and facilitates viability, growth, and biological activity of the beneficial microorganism.

Paragraph 3. The embodiment of Paragraph 1 or 2, further comprising one or more additional components selected from the group consisting of castor oil alkoxylates, alpha olefin sulfonates, polyoxyethylene sorbitan monooleates, sodium gluconate, alkenyl dimethyl amides, a blend of sodium alkyl ether sulfate with alkylamidopropyl betaine and/or alkyl betaine, and combinations thereof.

Paragraph 4. The embodiment in any preceding Paragraph 1-3, further comprising a hydrotrope, preferably sodium xylene sulfonate, sodium cumene sulfonate, amphoteric dipropionate salt, or combinations thereof.

Paragraph 5. The embodiment of any preceding Paragraph 1-4, further comprising one or more additional carbohydrates selected from the group consisting of cellulose, maltodextrin, fiber, amylose, amylopectin, glycogen, and starch.

Paragraph 6. The embodiment of any preceding Paragraph 1-5, further comprising at least one enzyme, preferably one or more proteases, amylases, lipases or combinations thereof.

Paragraph 7. The embodiment of any preceding Paragraph 1-6, wherein surfactant (a) is one or more rhamnolipids, and the additive comprises L-alanine and MgCl₂ in a weight ratio of 1:1 or greater, or the additive comprises L-alanine and MgCl₂ in a weight ratio of MgCl₂:L-alanine of 1:1 or greater in combination with glucose in an amount not greater than the weight of (MgCl₂+L-alanine) in the composition.

Paragraph 8. The embodiment of any preceding Paragraph 1-6, wherein surfactant (a) is one or more rhamnolipids, and the additive comprises a combination of L-alanine, MgCl₂, and KNO₃ in a weight ratio of (L-alanine plus MgCl₂):KNO₃ of 4:1 or greater, or the additive comprises a combination of L-alanine, MgCl₂, and KNO₃ in a weight ratio of MgCl₂:(L-alanine plus KNO₃) of 1:1 or greater in combination with glucose in an amount not greater than the weight of (L-alanine+MgCl₂+KNO₃) in the composition.

Paragraph 9. The embodiment of Paragraph 7 or 8, wherein the composition comprises 5%-10% by active weight rhamnolipids and 5%-10% by weight additive, or 0.05%-1.0% by active weight rhamnolipids, and 0.05%-1.0% by weight of additive.

Paragraph 10. The embodiment of any preceding Paragraph 1-6, wherein surfactant (a) is an alkyl sarcosinate, and the additive comprises a combination of L-alanine, KNO3 and glucose in a weight ratio of (KNO₃ plus L-alanine):glucose of 1:1 or greater, or the additive comprises a combination of L-alanine, KNO₃ and glucose in a weight ratio of KNO₃:(L-alanine plus glucose) of 2:1 or greater.

Paragraph 11. The embodiment of Paragraph 10, wherein the alkyl sarcosinate is sodium lauroyl sarcosinate, and the composition comprises 5%-20% by active weight sodium lauroyl sarcosinate, and 5%-20% by weight additive, or the composition comprises 0.05%-1.0% by active weight sodium lauroyl sarcosinate, and from 0.05%-1.0% by weight additive.

Paragraph 12. The embodiment of any preceding Paragraph 1-6, wherein surfactant (a) is a sulfonated alkyl ester, and the additive comprises a combination of L-alanine, MgCl₂, and KNO₃ in a weight ratio of (L-alanine plus KNO₃):MgCl₂ of 3:1 or greater, or the additive comprises a combination of L-alanine, MgCl₂, and KNO₃ in a weight ratio of KNO₃:(L-alanine plus MgCl₂) of 1:1 or greater in combination with glucose in an amount not greater than the weight of (L-alanine+MgCl₂+KNO₃) in the composition.

Paragraph 13. The embodiment of Paragraph 12, wherein the composition comprises 0.05%-1.0% by active weight sulfonated alkyl ester, and from 0.05%-1.0% by weight additive.

Paragraph 14. The embodiment of any preceding Paragraph 1-13, further comprising spores of a live beneficial microorganism, such as spores of one or more fungi, yeast, or bacterial spores, preferably bacterial spores, more preferably spores of one or more Bacillus species, such as spores of Bacillus amyloliquefaciens, Bacillus brevis, Bacillus circulans, Bacillus clausii, Bacillus coagulans, Bacillus firmus, Bacillus halodurans, Bacillus lentus, Bacillus licheniformis, Bacillus megaterium, Bacillus methylotrophicus, Bacillus mycoides, Bacillus pasteurii, Bacillus, polyfermenticus, Bacillus polymyxa, Bacillus pumilus, Bacillus simplex, Bacillus sphaericus, Bacillus stearothermophilus, Bacillus subtilis, Bacillus thiaminolyticus, or Bacillus thuringiensis.

Paragraph 15. The embodiment of Paragraph 14, wherein the spores are in an amount of 1×10⁷ to 1×10¹⁰, preferably 1×10⁹ to 5×10⁹ CFU/g, or in an amount of 1×10⁵ to 1×10⁹.

Paragraph 16. The embodiment of any preceding Paragraph 1-13, wherein a bacteria, a fungi, or a yeast is the live beneficial microorganism.

Paragraph 17. The embodiment of any preceding Paragraph 1-16, further comprising at least one preservative selected from the group consisting of phenoxyethanol, methyl isothiazolinone, benzylisothiazolinone, benzyl alcohol, fatty acids, benzoic acid, and combinations thereof.

Paragraph 18. The embodiment of any preceding Paragraph 2-15 or 17, wherein the live beneficial microorganism comprises microbial spores and the microbial spores are added to the aqueous composition in the absence of the additive to maintain the microbial spores in an inactive state; and thereafter the additive is added to the aqueous composition to activate the microbial spores.

Paragraph 19. A method for environmental remediation of soil comprising applying an aqueous composition comprising from 0.1% to 25% by active weight rhamnolipids to the soil to be remediated; applying a composition to the soil to be remediated, wherein the composition comprises (a) an additive comprising (i) a blend of L-alanine and MgCl2 in an amount of 0.1% to 25% by weight based on the weight of the composition and in a weight ratio of L-alanine:MgCl2 of 1:1 or greater, and (ii) optionally, at least one carbohydrate, (b) live beneficial microbial spores in an amount of 1×10⁶ to 1×10¹⁰ CFU/g, and (c) a carrier to total 100% by weight of the composition, or the composition comprises (a) an additive comprising (i) a blend of L-alanine and MgCl2 in an amount of 0.1% to 25% by weight based on the weight of the composition and in a weight ratio of MgCl2:L-alanine of 1:1 or greater, (ii) glucose in an amount not greater than the weight of (L-alanine+MgCl2) in the additive composition, (b) live beneficial microbial spores in an amount of 1×10⁶ to 1×10¹⁰ CFU/g, and (c) a carrier to total 100% by weight of the composition.

Paragraph 20. The embodiment of Paragraph 19, wherein the aqueous composition comprising rhamnolipids and the composition comprising the additive are each applied to the soil in an amount of about 1 to about 200 g/kg of soil.

Paragraph 21. A microbial enhanced cleaning composition comprising (a) about 0.05% to 1.0% by active weight of at least one surfactant that exhibits antagonistic surfactant incompatibility when in contact with a live beneficial microorganism and adversely affects viability, growth, or biological activity of the live beneficial microorganism, wherein the surfactant comprises one or more of alkyl sulfates, alkyl sulfonates, alpha sulfonated alkyl esters, alkyl sarcosinates, alkyl glutamates, alkyl ether sulfates, alkyl betaines, alkyl amidopropyl betaines, alkyl amine oxides, alkyl amine alkoxylates, quaternized alkyl amine alkoxylates, sulfonated alkyl esters, alkyl sulfoacetates, alcohol alkoxylates, EO/PO block copolymers, phosphate ester salts, sulfosuccinates, mono- and/or diglycerides, hydroxy sultaines, or rhamnolipids; (b) about 0.05% to 1.0% by weight of an additive that overcomes the antagonistic surfactant incompatibility between the at least one surfactant and the live beneficial microorganism, and facilitates viability, growth, and biological activity of the beneficial microorganism, wherein the additive comprises (i) at least one L-amino acid selected from the group consisting of histidine, isoleucine, leucine, lysine, methionine, phenylalanine, threonine, tryptophan, valine, alanine, asparagine, aspartic acid, glutamic acid, serine, arginine, cysteine, glutamine, glycine, proline, and tyrosine; (ii) at least one inorganic divalent metal salt or at least one monovalent salt, or a combination thereof, wherein the inorganic divalent metal salt is magnesium chloride, calcium chloride, manganese chloride, iron chloride, copper chloride, zinc chloride, cobalt chloride, magnesium nitrate, magnesium sulfate, calcium sulfate, manganese sulfate, iron sulfate, copper sulfate, zinc sulfate, colbalt sulfate, magnesium citrate, calcium citrate, hydrates of any of the foregoing, or combinations of any of the foregoing, and the monovalent salt is potassium nitrate (KNO₃), sodium nitrate, potassium iodide, potassium chloride, potassium manganese oxide, potassium sulfate, sodium bicarbonate, sodium sulfate, ammonium nitrate, ammonium sulfate, ammonium chloride, sodium citrate, potassium citrate, or ammonium citrate, or combinations thereof; (iii) optionally, one or more carbohydrates comprising glucose, maltose, galactose, fructose, sucrose, lactose, molasses, glycogen, or glucans; (c) microbial spores in an amount of 1×10⁴ to about 1×10⁸ CFU/g; and (d) water to total 100% by weight of the composition.

Paragraph 22. The embodiment of Paragraph 21, wherein surfactant (a) is one or more rhamnolipids, and the additive comprises L-alanine and MgCl2 in a weight ratio of 1:1 or greater, or the additive comprises L-alanine and MgCl2 in a weight ratio of MgCl2:L-alanine of 1:1 or greater in combination with glucose in an amount not greater than the weight of (MgCl2+L-alanine) in the composition.

Paragraph 23. The embodiment of Paragraph 21, wherein surfactant (a) is one or more rhamnolipids, and the additive comprises a combination of L-alanine, MgCl2, and KNO3 in a weight ratio of (L-alanine plus MgCl2):KNO3 of 4:1 or greater, or the additive comprises a combination of L-alanine, MgCl2, and KNO3 in a weight ratio of MgCl2:(L-alanine plus KNO3) of 1:1 or greater in combination with glucose in an amount not greater than the weight of (L-alanine+MgCl2+KNO3) in the composition.

Paragraph 24. The embodiment of Paragraph 21, wherein surfactant (a) is an alkyl sarcosinate, and the additive comprises a combination of L-alanine, KNO3 and glucose in a weight ratio of (KNO3 plus L-alanine):glucose of 1:1 or greater, or the additive comprises a combination of L-alanine, KNO3 and glucose in a weight ratio of KNO3:(L-alanine plus glucose) of 2:1 or greater.

Paragraph 25. The embodiment of Paragraph 21, wherein surfactant (a) is an alkyl sarcosinate, and the additive comprises a combination of L-alanine, KNO3 and glucose in a weight ratio of (KNO3 plus L-alanine):glucose of 1:1 or greater, or the additive comprises a combination of L-alanine, KNO3 and glucose in a weight ratio of KNO3:(L-alanine plus glucose) of 2:1 or greater.

Paragraph 26. The embodiment of any of Paragraphs 21-25, wherein the spores are one or more fungi, yeast, or bacterial spores, preferably bacterial spores, more preferably spores of one or more Bacillus species, such as spores of Bacillus amyloliquefaciens, Bacillus brevis, Bacillus circulans, Bacillus clausii, Bacillus coagulans, Bacillus firmus, Bacillus halodurans, Bacillus lentus, Bacillus licheniformis, Bacillus megaterium, Bacillus methylotrophicus, Bacillus mycoides, Bacillus pasteurii, Bacillus, polyfermenticus, Bacillus polymyxa, Bacillus pumilus, Bacillus simplex, Bacillus sphaericus, Bacillus stearothermophilus, Bacillus subtilis, Bacillus thiaminolyticus, or Bacillus thuringiensis.

Paragraph 27. The embodiment of any of Paragraphs 21-26, further comprising one or more additional components selected from the group consisting of castor oil alkoxylates, alpha olefin sulfonates, polyoxyethylene sorbitan monooleates, sodium gluconate, alkenyl dimethyl amides, a blend of sodium alkyl ether sulfate with alkylamidopropyl betaine and/or alkyl betaine, and combinations thereof.

Paragraph 28. A composition for overcoming antagonistic surfactant incompatibility between an alkyl ether sulfate surfactant and a live beneficial microorganism, wherein the surfactant incompatibility adversely affects viability, growth, or biological activity of a live beneficial microorganism, wherein the composition comprises (a) from 5% to 20% by active weight of an alkyl ether sulfate surfactant that exhibits antagonistic surfactant incompatibility when in contact with a live beneficial microorganism and adversely affects viability, growth, or biological activity of the live beneficial microorganism; (b) from 1% to 10% by weight of an additive comprising (i) at least one monovalent salt comprising potassium nitrate (KNO₃), sodium nitrate, potassium iodide, potassium chloride, potassium manganese oxide, potassium sulfate, sodium bicarbonate, sodium sulfate, ammonium nitrate, ammonium sulfate, ammonium chloride, sodium citrate, potassium citrate, or ammonium citrate, or combinations thereof; (ii) at least one inorganic divalent metal salt comprising magnesium chloride, calcium chloride, manganese chloride, iron chloride, copper chloride, zinc chloride, cobalt chloride, magnesium nitrate, magnesium sulfate, calcium sulfate, manganese sulfate, iron sulfate, copper sulfate, zinc sulfate, colbalt sulfate, magnesium citrate, calcium citrate, hydrates of any of the foregoing, or combinations of any of the foregoing; (c) an alkoxylated castor oil; and (d) water to total 100% by weight of the composition, wherein the combination of the additive and the alkoxylated castor oil overcome the antagonistic surfactant incompatibility between the alkyl ether sulfate surfactant and the live beneficial microorganism, and facilitate viability, growth, and biological activity of the beneficial microorganism when the composition is combined with the live beneficial microorganism.

The present technology is now described in such full, clear and concise terms as to enable a person skilled in the art to which it pertains, to practice the same. It is to be understood that the foregoing describes preferred embodiments of the present technology and that modifications may be made therein without departing from the spirit or scope of the present technology as set forth in the appended claims. Further, the examples are provided to not be exhaustive but illustrative of several embodiments that fall within the scope of the claims.

What is claimed is:

1. A composition for overcoming antagonistic surfactant incompatibility between a surfactant and a live beneficial microorganism, wherein the surfactant incompatibility adversely affects viability, growth, or biological activity of a live beneficial microorganism, the composition comprising:
(a) at least one surfactant that exhibits antagonistic surfactant incompatibility when in contact with a live beneficial microorganism and adversely affects viability, growth, or biological activity of the live beneficial microorganism;
(b) an additive comprising:
(i) at least one L-amino acid in combination with at least one of inorganic divalent metal salts or monovalent salts in an amount to provide a weight ratio of additive component (i) to surfactant of 0.2:1 to 1:1; and
(ii) optionally, at least one carbohydrate; and
(c) water to total 100 wt % of the composition,
wherein, when the composition is combined with the live beneficial microorganism, the additive in the composition overcomes the antagonistic surfactant incompatibility between the at least one surfactant and the live beneficial microorganism, and facilitates viability, growth, and biological activity of the beneficial microorganism.

2. The composition of claim 1, wherein the surfactant (a) is one or more of alkyl sulfates, alkyl sulfonates, alpha sulfonated alkyl esters, alkyl sarcosinates, alkyl glutamates, alkyl ether sulfates, alkyl betaines, alkyl amidopropyl betaines, alkyl amine oxides, alkyl amine alkoxylates, quaternized alkyl amine alkoxylates, sulfonated alkyl esters, alkyl sulfoacetates, alcohol alkoxylates, EO/PO block copolymers, phosphate ester salts, sulfosuccinates, mono- and/or diglycerides, hydroxy sultaines, or rhamnolipids.

3. The composition of claim 1, wherein the L-amino acid is selected from the group consisting of histidine, isoleucine, leucine, lysine, methionine, phenylalanine, threonine, tryptophan, valine, alanine, asparagine, aspartic acid, glutamic acid, serine, arginine, cysteine, glutamine, glycine, proline, and tyrosine.

4. The composition of claim 1, wherein the inorganic divalent metal salt is selected from the group consisting of magnesium chloride, calcium chloride, manganese chloride, iron chloride, copper chloride, zinc chloride, cobalt chloride, magnesium nitrate, magnesium sulfate, calcium sulfate, manganese sulfate, iron sulfate, copper sulfate, zinc sulfate, colbalt sulfate, magnesium citrate, calcium citrate, hydrates of any of the foregoing, and combinations of any of the foregoing.

5. The composition of claim 1, wherein the monovalent salt is potassium nitrate (KNO₃), sodium nitrate, potassium iodide, potassium chloride, potassium manganese oxide, potassium sulfate, sodium bicarbonate, sodium sulfate, ammonium nitrate, ammonium sulfate, ammonium chloride, sodium citrate, potassium citrate, or ammonium citrate, or combinations thereof.

6. The composition of claim 1, wherein the carbohydrate is one or more of glucose, maltose, galactose, fructose, sucrose, lactose, molasses, glycogen, or glucans.

7. The composition of claim 1, wherein surfactant (a) is one or more rhamnolipids, and the additive comprises the L-amino acid, the divalent metal salt, and optionally the carbohydrate.

8. The composition of claim 1, wherein surfactant (a) is one or more rhamnolipids, and the additive comprises the L-amino acid, the divalent metal salt, the monovalent salt, and optionally the carbohydrate.

9. The composition of claim 7, wherein the composition comprises 5%-10% by active weight rhamnolipids and 5%-10% by weight additive.

10. The composition of claim 7, wherein the composition comprises 0.05%-1.0% by active weight rhamnolipids, and 0.05%-1.0% by weight of additive.

11. The composition of claim 1, wherein surfactant (a) is an alkyl sarcosinate, and the additive comprises the L-amino acid, the monovalent salt, and the carbohydrate.

12. The composition of claim 11, wherein the alkyl sarcosinate in the composition is in an amount of 5%-20% by active weight, and the additive is in the composition in an amount of 5%-20% by weight.

13. The composition of claim 11, wherein the alkyl sarcosinate in the composition is in an amount of 0.05%-1.0% by active weight, and the additive is in an amount of 0.05%-1.0% by weight.

14. The composition of claim 1, wherein surfactant (a) is a sulfonated alkyl ester, and the additive comprises the L-amino acid, the monovalent salt, the divalent metal salt, and optionally the carbohydrate.

15. The composition of claim 14, wherein the composition comprises 0.05%-1.0% by active weight sulfonated methyl ester and 0.05%-1.0% additive.

16. The composition of claim 1, further comprising spores of a live beneficial microorganism.

17. The composition of claim 16, wherein the spores are in an amount of 1×10⁷ to 1×10¹⁰, preferably 1×10⁹ to 5×10⁹ CFU/g, or in an amount of 1×10⁵ to 1×10⁹.

18. A method for overcoming antagonistic surfactant incompatibility between a surfactant and a live beneficial microorganism, wherein the surfactant incompatibility adversely affects viability, growth, or biological activity of a live beneficial microorganism, the method comprising:
(a) providing an aqueous composition comprising at least one surfactant that exhibits antagonistic surfactant incompatibility when in contact with a live beneficial microorganism and adversely affects viability, growth, or biological activity of the live beneficial microorganism;
(b) combining an additive with the aqueous composition, wherein the additive comprises:
(i) at least one L-amino acid in combination with at least one of inorganic divalent metal salts or monovalent salts in an amount to provide a weight ratio of additive component (i) to surfactant of 0.2:1 to 1:1; and
(ii) optionally, at least one carbohydrate; and
(c) combining the live beneficial microorganism with the aqueous composition before step (b) or after step (b);
wherein the additive overcomes the antagonistic surfactant incompatibility between the at least one surfactant and the live beneficial microorganism, and facilitates viability, growth, and biological activity of the beneficial microorganism.

19. A method for environmental remediation of soil comprising:
(a) applying an aqueous composition comprising from 0.1% to 25% by active weight rhamnolipids to the soil to be remediated;
(b) applying a composition to the soil to be remediated, wherein the composition comprises (i) an additive comprising a blend of L-amino acid and divalent metal salt in an amount of 0.1% to 25% by weight of the composition and optionally, at least one carbohydrate in an amount not greater than the weight of the blend of L-amino acid and divalent metal salt in the composition, (ii) live beneficial microbial spores in an amount of 1×10⁶ to 1×10¹⁰ CFU/g, and (iii) a carrier to total 100% by weight of the composition.

20. A microbial enhanced cleaning composition comprising:
(a) about 0.05% to 1.0% by active weight of at least one surfactant that exhibits antagonistic surfactant incompatibility when in contact with a live beneficial microorganism and adversely affects viability, growth, or biological activity of the live beneficial microorganism;
(b) about 0.05% to 1.0% by weight of an additive that overcomes the antagonistic surfactant incompatibility between the at least one surfactant and the live beneficial microorganism, and facilitates viability, growth, and biological activity of the beneficial microorganism, the additive comprising:
(i) at least one L-amino acid;
(ii) at least one inorganic divalent metal salt or at least one monovalent salt, or a combination thereof;
(iii) optionally, at least one carbohydrate;
(c) microbial spores in an amount of 1×10⁴ to about 1×10⁸ CFU/g; and
(d) water to total 100% of the composition.
